(19) United States
(12) Patent Application Publication
(10) Pub. No.: US 2015/0132696 A1
(43) Pub. Date: May 14, 2015

(54) TONER, DEVELOPER, IMAGE FORMING APPARATUS, PARTICLES, METHOD FOR PRODUCING TONER AND METHOD FOR PRODUCING PARTICLES

(71) Applicants: Keiko Osaka, Shizuoka (JP); Chiaki Tanaka, Shizuoka (JP); Masaki Watanabe, Shizuoka (JP)

(72) Inventors: Keiko Osaka, Shizuoka (JP); Chiaki Tanaka, Shizuoka (JP); Masaki Watanabe, Shizuoka (JP)

(21) Appl. No.: 14/397,553

(22) PCT Filed: Apr. 30, 2013
(86) PCT No.: PCT/JP2013/062987

§ 371 Date: Oct. 28, 2014

(30) Foreign Application Priority Data
May 1, 2012 (JP) 2012-104572
Dec. 27, 2012 (JP) 2012-286025
Jan. 30, 2013 (JP) 2013-015719

(51) Int. Cl. G03G 9/087; G03G 9/08

(52) U.S. Cl. CPC G03G 9/08764; G03G 9/0819; G03G 9/081
USPC 430/109.1; 430/137.1

(57) ABSTRACT

A toner, including: a binder resin; and a releasing agent, wherein the toner includes a pressure plastic material as the binder resin, wherein the releasing agent includes a plurality of particulate releasing agents, and wherein the particulate releasing agents forming domain phases are dispersed in the pressure plastic material forming a continuous phase.

### TECHNICAL FIELD

The present invention relates to a toner, a developer, an image forming apparatus, particles, a method for producing a toner and a method for producing particles.

### BACKGROUND ART

As a method to fix a toner image formed on an image substrate such as paper, a heat roller fixing method has been widely adopted, wherein the image substrate is passed between a heat roller and a pressure roller for fixing. A technology to impart releasing property to the toner itself by adding a releasing agent such as wax in the toner has been employed in recent years in order to prevent an offset phenomenon that a melted toner adheres to the heat roller.

Meanwhile, a method of melting and kneading materials including a thermoplastic resin and an additive such as releasing agent and cooling and solidifying the kneaded product, followed by pulverization to form particles has been known as a method for producing a toner. At this time, in order to control a particle shape of a toner, PTL 1 discloses a method for producing a toner by: kneading and pulverizing materials including a thermoplastic resin; dispersing the pulverized product in an aqueous solvent under the presence of hydrophilic inorganic fine particles; and removing the solvent.

### CITATION LIST

### Patent Literature

PTL 1 Japanese Patent Application Laid-Open No. 09-34167

### SUMMARY OF INVENTION

### Technical Problem

However, by the method for producing a toner described in PTL 1, it was difficult to control a particle diameter of releasing agent particles dispersed in the thermoplastic resin. Thus, the releasing agent as coarse particles was mixed in the toner alone, and there were cases where the toner had degraded charging property, fixability and so on.

The present invention aims at solving the above problems in the conventional technologies and at achieving the following objection. That is, an object of the present invention is to provide a toner having superior charging property and fixability.

### Solution to Problem

Means for solving the problems are as follows. That is,

a toner of the present invention includes: a binder resin; and a releasing agent,

wherein the toner includes a pressure plastic material as the binder resin,

wherein the releasing agent includes a plurality of particulate releasing agents, and

wherein the particulate releasing agents forming domain phases are dispersed in the pressure plastic material forming a continuous phase.

### Advantageous Effects of Invention

The present invention may solve the conventional problems and achieve the objectives above and provide a toner having superior charging property and fixability.

### BRIEF DESCRIPTION OF DRAWINGS

FIG. 1A is a schematic diagram for explaining one example of a toner of the present invention.

FIG. 1B is a schematic diagram for explaining one example of a conventional toner.

FIG. 2 is a diagram for explaining an example of a pressure plastic material of the present invention, and it is a schematic diagram illustrating a relation between a glass transition temperature and a pressure.

FIG. 3 is a phase diagram for explaining a state of a substance at a certain temperature and pressure condition.

FIG. 4 is a phase diagram for explaining a compressive fluid in the present invention.

FIG. 5 is a schematic diagram of an apparatus for producing particles relating to one embodiment of the present invention.

FIG. 6 is a schematic diagram of an apparatus for producing particles relating to another embodiment of the present invention.

FIG. 7 is a schematic diagram of an apparatus for producing particles relating to yet another embodiment of the present invention.

FIG. 8 is a schematic diagram of an apparatus for producing particles relating to yet another embodiment of the present invention.

FIG. 9 is a schematic diagram of an apparatus for producing particles relating to yet another embodiment of the present invention.

FIG. 10 is a schematic diagram illustrating an image forming apparatus relating to the present invention.

### DESCRIPTION OF EMBODIMENTS

Hereinafter, the present invention is explained in more detail in reference to diagrams. Here, in the present embodiments, a toner having superior charging property and fixability, which is produced by a novel method for producing a toner is described as one example, but the method for producing the toner of the present embodiments may be applied to a method for producing particles other than a toner.

Here, in the present embodiments, “melting” means that materials such as pressure plastic material swell as well as are plasticized, semi-liquefied and liquefied by contacting a compressive fluid and that the materials such as pressure plastic material are plasticized, semi-liquefied and liquefied by heating. Also, in the present embodiments, “raw materials” denotes a material including components of particles for producing particles (toner in the present embodiments).

### (Toner)

First, a structure of the toner of the present embodiments is explained.

A toner of the present embodiments includes a binder resin and a releasing agent, and it further includes other components according to necessity.

The toner includes: a pressure plastic material as the binder resin; and a plurality of “particulate” releasing agents.

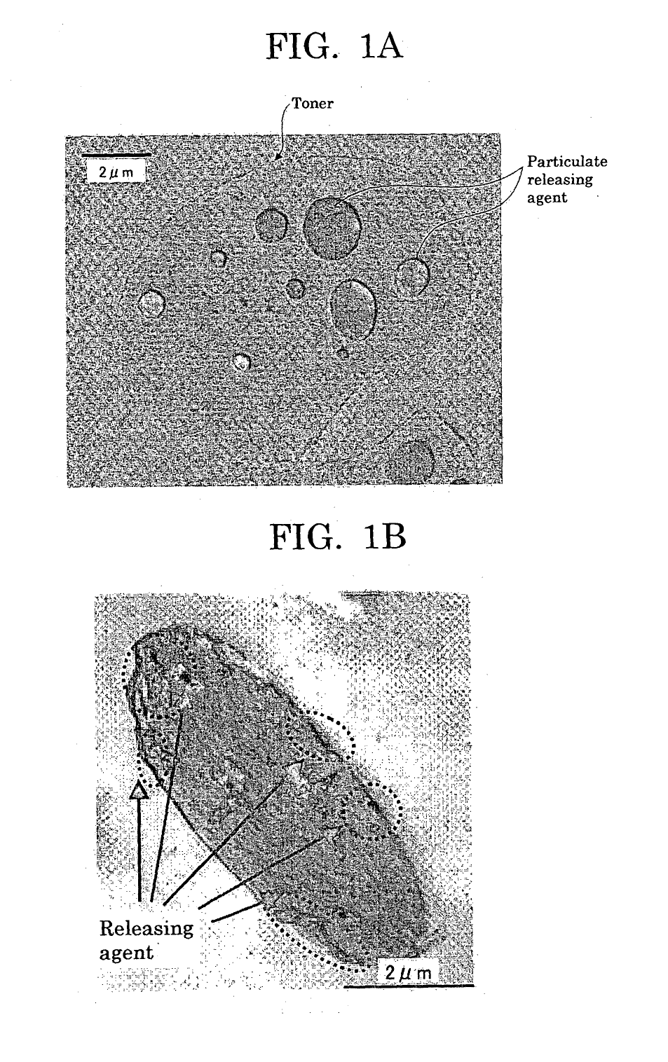

FIG. 1A and FIG. 1B illustrate schematic diagrams for explaining one example of the toner of the present embodiments. Specifically, FIG. 1A is a cross-sectional SEM image of the toner of the present embodiments, and FIG. 1B is a cross-sectional TEM image of a conventional toner.

As it is clear from a comparison of FIG. 1A and FIG. 1B, the toner of the present embodiments includes a plurality of “particulate” releasing agents. In this case, although it is not restricted, the toner of the present embodiments preferably includes the particulate releasing agents forming domain phases dispersed in the pressure plastic material forming a continuous phase. Also, the particulate releasing agents are substantially spherical, and the particulate releasing agents have an average maximum Feret diameter of preferably 300 nm or greater but less than 1.5 μm. The toner of the present embodiments includes a plurality of “particulate” releasing agents. The particulate releasing agents are substantially spherical, and the “particulate” releasing agents have an average maximum Feret diameter of 300 nm or greater but less than 1.5 μm. Thereby, a toner spent due to a needle-like releasing agent protruding from a binder resin, which occurred with a conventional toner, may be efficiently prevented.

Here, the “particulate” releasing agent refers to a releasing agent existing in the toner in a substantially spherical shape, meaning a releasing agent having a substantially circular cross-section with an aspect ratio (major axis/minor axis) of 1.0 to 2.0 when a cross-section of the toner is observed by an electron microscope. The toner of the present invention contains such a particulate releasing agent only, and does not contain a releasing agent having a so-called needle shape or a clearly non-circular releasing agent having convex and concave portions in the cross-section of the toner.

The aspect ratio of the releasing agent is calculated as follows. Specifically, a cross-section of the toner is observed by, for example, an electron microscope, and a cross-sectional photograph is taken. The cross-sectional photograph is processed and binarized by image processing software, and releasing-agent portions are identified. The aspect ratio of the identified releasing-agent portions is determined by dividing the major axis of the releasing agent by the minor axis of the releasing agent.

The maximum Feret diameter refers to a diameter with which parallel lines which sandwich an object have the largest interval.

Here, an average value of the maximum Feret diameters of the particulate releasing agents is obtained as follows. Specifically, a cross-section of the toner is observed by, for example, an electron microscope, and a cross-sectional photograph is taken. The cross-sectional photograph is processed and binarized by image processing software, and releasing-agent portions are identified. Among the maximum Feret diameters of the identified releasing-agent particles or the pores, 30 of them are selected in order of larger diameter, and an average thereof is regarded as the average of the maximum Feret diameter of the releasing agent.

### <<Binder Resin>>

The binder resin is not particularly restricted, and it may be appropriately selected according to purpose. Also, the binder resin may be a binder resin as a combination of a crystalline resin and a non-crystalline resin, but it is practically preferable that a main component of the binder resin is a crystalline resin. It is preferable to include a crystalline resin by 50% by mass or greater with respect to the binder resin.

A content of the crystalline resin with respect to the binder resin is not particularly restricted, and it may be appropriately selected according to purpose. However, it is preferably 50% by mass or greater in view of maximizing both superior low-temperature fixing property and heat-resistant storage stability by the crystalline resin, it is more preferably 65% by mass or greater, further more preferably 80% by mass or greater, and particularly preferably 95% by mass or greater. When the content of the crystalline resin is less than 50% by mass, thermal steepness of the binder resin cannot be developed on viscoelastic properties of the toner, and there are cases where achieving both low-temperature fixing property and heat-resistant storage stability is difficult.

Here, a “crystalline” resin in the present embodiments refers to those having a ratio of a softening temperature measured by a Koka flow tester to a maximum peak temperature of heat of fusion measured by a differential scanning calorimeter (DSC) (softening temperature/maximum peak temperature of heat of fusion) in a range of 0.8 to 1.55. Because of the parameter within this range, it has a property to soften steeply due to heat.

Also, a “non-crystalline” resin refers to a resin having a ratio of a softening temperature and a maximum peak temperature of heat of fusion (softening temperature/maximum peak temperature of heat of fusion) is greater than 1.55. Because of the parameter within this range, it has a property to soften gradually due to heat.

Here, the softening temperatures of the resin and the toner maybe measured using a Koka flow tester (for example, CFT-500D, manufactured by Shimadzu Corporation). As a measurement method, first, a load of 1.96 MPa is applied on 1 g of the resin as a sample by a plunger while heating at a heating rate of 6° C./min. Then, the sample is extruded from a nozzle having a diameter of 1 mm and a length of 1 mm. Then, an amount of descent of the plunger of the flow tester with respect to a temperature is plotted, and a temperature at which half of an amount of the sample is extruded is flown out is regarded as a softening temperature.

The maximum peak temperature of heat of fusion of the resin and the toner may be measured using a differential scanning calorimeter (DSC) (e.g., TA-60WS and DSC-60, manufactured by Shimadzu Corporation). As a measurement method, first, as a pre-treatment, a measurement sample is melted at 130° C., then cooled from 130° C. to 70° C. at a rate of 1.0° C./min and then cooled from 70° C. to 10° C. at a rate of 0.5° C./min. Here, by the DSC, the sample is heated at a heating rate of 20° C./min to measure an endothermic/exothermic change, and a graph of “endothermic/exothermic quantity” and “temperature” is drawn. An endothermic peak temperature observed at 20° C. to 100° C. is defined as “Ta*”. When there is a plurality of endothermic peaks, a temperature of a peak having the largest endothermic quantity is defined as Ta*. Thereafter, the sample is stored at (Ta*−10)° C. for 6 hours and further stored at (Ta*−15°)° C. for 6 hours. Next, the sample is cooled by the DSC at a cooling rate of 10° C./min to 0° C. and then heated at a heating rate of 20° C./min. The endothermic/exothermic change is measured, and a similar graph is drawn, and a temperature corresponding to a maximum peak of the endothermic/exothermic quantity is referred to as the maximum peak temperature of heat of fusion.

Also, the pressure plastic material preferably includes a crystalline resin (i.e., a crystalline resin having pressure plasticity). When the pressure plastic material is a crystalline resin, it is possible to obtain a toner by melting the crystalline resin with a compressive fluid according to a method described later without using an organic solvent, followed by spray granulation.

Also, by a method for producing the toner of the present embodiments, a colorant may be uniformly dispersed. By a method for producing a conventional toner with a crystalline resin as a main component, it has been difficult to uniformly disperse a colorant in the toner. However, by the method for producing the toner of the present embodiments, a colorant may be uniformly dispersed.

### —Pressure Plastic Material—

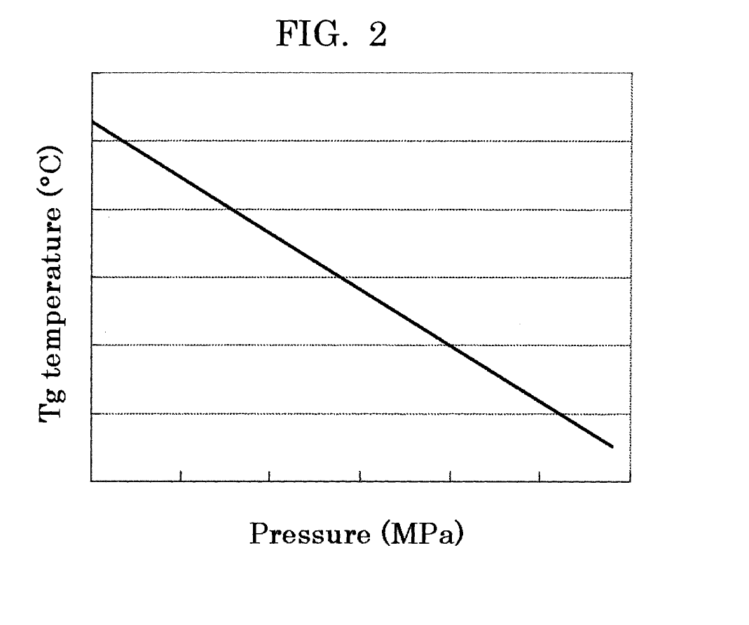

The toner of the present invention and the pressure plastic material as one of the raw materials of the toner is explained. FIG. 2 is a diagram for explaining an example of the pressure plastic material of the present embodiments, and it is a schematic diagram illustrating a relation between a glass transition temperature and a pressure. Here, in FIG. 2, a vertical axis is a glass transition temperature, and a horizontal axis is a pressure.

In the present embodiments, the pressure plastic material refers to a material characterized by a decreasing glass transition temperature (Tg) upon pressurization. Specifically, it refers to a material which plasticizes by pressurization without heating. Thus, the pressure plastic material plasticizes at a temperature lower than the glass transition temperature of the pressure plastic material at atmospheric pressure, for example, by bringing it into contact with a compressive fluid described later.

FIG. 2 illustrates a relation between a glass transition temperature of polystyrene and a pressure under the presence of carbon dioxide as an example of the pressure plastic material. As it is clear from FIG. 2, there is a correlation between the glass transition temperature of polystyrene and the pressure, and in the axis of FIG. 2, a slope thereof is negative. Like polystyrene, the pressure plastic material usually has a negative slope of a change in glass transition temperature with respect to an applied pressure. This slope varies depending on the types, composition or molecular weight of the pressure plastic material.

As examples of the above-described slope: polystyrene: −9° C./MPa; styrene-acrylic resin: −9° C./MPa; non-crystalline polyester resin: −8° C./MPa; crystalline polyester: −2° C./MPa; polyol resin: −8° C./MPa; urethane resin: −7° C./MPa; polyarylate resin: −11° C./MPa; and polycarbonate resin: −10° C./MPa.

As a method for measuring a slope, for example, using a high-pressure calorimeter apparatus C-80 (manufactured by SETARAM), a glass transition temperature is measured with a pressure varied, and thereby the slope is obtained. In the present embodiments, a sample is set in a high-pressure measuring cell. The cell is purged with carbon dioxide and then pressurized to a predetermined pressure, and then a glass transition temperature is measured. Also, the slope may be determined based on an amount of change in the glass transition temperature with the pressure varied from atmospheric pressure (0.1 MPa) to 10 MPa.

The slope as a change in the glass transition temperature of the pressure plastic material with respect to the pressure applied to the pressure plastic material is not particularly restricted, and it may be appropriately selected according to purpose. Nonetheless, it is preferably −1° C./MPa or less, more preferably −5° C./MPa or less, and further preferably −10° C./MPa or less. When the slope as a change in the glass transition temperature with respect to the pressure exceeds −1° C./MPa, plasticization upon pressurization without heating is insufficient, and consequently it becomes difficult to lower a viscosity of a melt described later. As a result, there are cases where granulation is difficult.

It is preferable that a material having a viscosity upon pressurization of 30 MPa or less of 500 mPa·s or less is used as the pressure plastic material used in the present embodiments. Here, in this case, it is also possible to heat the pressure plastic material below a melting point at a normal pressure so that it has a viscosity of 500 mPa·s or less under a condition of 30 MPa or less.

The pressure plastic material is not particularly restricted, and it may be appropriately selected according to purpose. Examples thereof include a polyester resin, a vinyl resin, a urethane resin, a polyol resin, a polyamide resin, an epoxy resin, rosin, modified rosin, a terpene resin, a phenolic resin, an aliphatic or alicyclic hydrocarbon resin, an aromatic petroleum resin, chlorinated paraffin, paraffin wax, polyethylene and polypropylene. These may be used alone or in combination of two or more.

The polyester resin is not particularly restricted, and it may be appropriately selected according to purpose. Examples thereof include modified polyester, non-modified polyester, non-crystalline polyester, crystalline polyester and a polylactic resin.

The polylactic resin is not particularly restricted, and it may be appropriately selected according to purpose. Examples thereof include a polylactic resin of an L-form, a D-form or a racemic form, a stereo-complex polylactic resin and a polylactic acid block copolymer.

As the polyol resin, a polyether polyol resin having an epoxy skeleton and so on may be used, and (i) an epoxy resin, (ii) an alkylene oxide adduct of dihydric phenol or a glycidyl ether thereof, (iii) a polyol resin obtained by reacting a compound containing an active hydrogen group reactive with an epoxy group and so on may be favorably used.

The vinyl resin is not particularly restricted, and it may be appropriately selected according to purpose. Examples thereof include: polymers of styrene and substituted derivatives thereof such as polystyrene, poly-p-chlorostyrene and polyvinyltoluene; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer and styrene-maleic acid ester copolymer; polymethyl methacrylate, polybutyl methacrylate, polyvinyl chloride, polyvinyl acetate; polymers of monomers such as vinyl propionate, (meth)acrylamide, vinyl methyl ether, vinyl ethyl ether, vinyl isobutyl ether, vinyl methyl ketone, N-vinylpyrrolidone, N-vinylpyridine and butadiene, copolymers of two or more types of these monomers, and mixtures thereof.

The urethane resin is not particularly restricted, and it may be appropriately selected and used according to purpose.

Also, in the present embodiments, the pressure plastic material preferably includes a resin containing a carbonyl group. A carbonyl group has a structure in which an oxygen atom having a high electronegativity is bonded to a carbon atom by a π bond. Since a n-bonding electron is strongly attracted to the oxygen atom, the oxygen atom is polarized negatively, and the carbon atom is polarized positively. Thus, the resin containing a carbonyl group has a high degree of reactivity. Also, when carbon dioxide is used as a compressive fluid described hereinafter, it is presumed that the carbonyl structure having a structure similar to a molecular structure of carbon dioxide increases affinity of carbon dioxide and pressure plastic material. Accordingly, it is considered that plasticization of the pressure plastic material by the compressive fluid becomes easier.

### —Crystalline Resin—

As described above, the binder resin preferably includes the crystalline resin. The crystalline resin is not particularly restricted as long as it has crystallinity, and it may be appropriately selected according to purpose. Examples thereof include a polyester resin, a polyurethane resin, a polyurea resin, a polyamide resin, a polyether resin, a vinyl resin and a modified crystalline resin. These may be used alone or in combination of two or more. Among these, the polyester resin is preferred in terms of low-temperature fixing property, and the polyurethane resin, the polyurea resin, the polyamide resin, the polyether resin, and a resin which includes a urethane skeleton or a urea skeleton, or both thereof are preferred. A straight-chain polyester resin and a complex resin including the straight-chain polyester resin are more preferred.

Here, favorable examples of the resin which includes a urethane skeleton or a urea skeleton, or both thereof include the polyurethane resin, the polyurea resin, a urethane-modified polyester resin and a urea-modified polyester resin. The urethane-modified polyester resin is a resin obtained by a reaction of a polyester resin containing an isocyanate group at an end thereof with a polyol. Also, the urea-modified polyester resin is a resin obtained by a reaction of a polyester resin containing an isocyanate group at an end thereof with amines.

The maximum peak temperature of heat of fusion of the crystalline resin is preferably in a range of 45° C. to 70° C., more preferably in a range of 53° C. to 65° C., and further more preferably in a range of 58° C. to 62° C. in view of achieving both low-temperature fixing property and heat-resistant storage stability. When the maximum peak temperature is less than 45° C., low-temperature fixing property improves, but there are cases where heat-resistant storage stability degrades. When it exceeds 70° C., heat-resistant storage stability improves, but there are cases where low-temperature fixing property degrades.

The ratio of the softening temperature to the maximum peak temperature of heat of fusion of the crystalline resin (softening temperature/maximum peak temperature of heat of fusion) is, as described above, in a range of 0.8 to 1.55. It is preferably in a range of 0.85 to 1.25, more preferably in a range of 0.9 to 1.2, and further more preferably in a range of 0.9 to 1.19. In general, the resin softens sharply as the ratio becomes smaller, which is preferable for achieving both low-temperature fixing property and heat-resistant storage stability.

Among viscoelastic properties of the crystalline resin, a storage elastic modulus G′ at (maximum peak temperature of heat of fusion)+20° C. is preferably 5.0×10⁶ Pa·s or less, more preferably in a range of 1.0×10¹ Pa·s to 5.0×10⁵ Pa·s, and further more preferably in a range of 1.0×10¹ Pa·s to 1.0×10⁴ Pa·s. Also, a loss elastic modulus G″ at (maximum peak temperature of heat of fusion)+20° C. is preferably 5.0×10⁶ Pa·s or less, more preferably in a range of 1.0×10¹ Pa·s to 5.0×10⁵ Pa·s, and further more preferably in a range of 1.0×10¹ Pa·s to 1.0×10⁴ Pa·s. Regarding viscoelastic properties of the toner of the present invention, given that G′ and G″ increases by dispersing a colorant or a layered inorganic mineral in the binder resin, the values of G′ and G″ at (maximum peak temperature of heat of fusion)+20° C. is preferably in a range of 1.0×10³ Pa·s to 5.0×10⁶ Pa·s.

Viscoelastic properties of the crystalline resin may be adjusted by adjusting a ratio of a crystalline monomer and a non-crystalline monomer which constitute the resin or a molecular weight of the resin. For example, in general, increasing the ratio of the crystalline monomer decreases the value of G′ (Ta+20).

The dynamic viscoelastic properties (storage elastic modulus G′, loss elastic modulus G″) of the resin and the toner may be measured using a dynamic viscoelasticity measuring apparatus (for example, ARES (manufactured by TA Instruments)). In this case, for example, it is measured under a condition of a frequency of 1 Hz. First, a sample is molded into a pellet having a diameter of 8 mm and a thickness of 1 mm to 2 mm and is fixed to a parallel plate having a diameter of 8 mm. After it is stabilized at 40° C., it was heated to 200° C. at a heating rate of 2.0° C./min at a frequency of 1 Hz (6.28 rad/s) and a strain amount of 0.1% (strain control mode), and a measurement is taken.

In view of fixability, the crystalline resin has a weight-average molecular weight (Mw) preferably in a range of 2,000 to 100,000, more preferably in a range of 5,000 to 60,000, and further more preferably in a range of 8,000 to 30,000. When the weight-average molecular weight is smaller than 2,000, hot-offset resistance is likely to degrade. When it exceeds 100,000, low-temperature fixing property tends to degrade.

In the present embodiments, the weight-average molecular weight (Mw) of the resin may be measured using a gel permeation chromatography (GPC) measuring apparatus (for example, GPC-8220GPC (manufactured by Tosoh Corporation)). As a column, TSKgel SuperHZM-H 15 cm (manufactured by Tosoh Corporation) was used in triplicate. A 0.15-% by mass tetrahydrofuran (THF) (including a stabilizer, manufactured by Wako Pure Chemical Industries, Ltd.) solution of the measuring resin is formed. It is filtered with a 0.2-μm filter, and a filtrate thereof is used as a sample. Then, 100 μL of the THF sample solution is injected in the measuring apparatus, and a measurement is taken at a flow rate of 0.35 mL/min under an environment of a temperature of 40° C. In the molecular-weight measurement of the sample, the molecular weight was calculated from a relation between logarithmic values and a number of counts of a calibration curve prepared from several types of monodisperse polystyrene standard samples. Showdex STANDARD, Std. Nos. S-7300, S-210, S-390, S-875, S-1980, S-10.9, S-629, S-3.0 and S-0.580, manufactured by Showa Denko KK, and toluene were used as the standard polystyrene samples. An RI (refractive index) detector was used for a detector.

### <Releasing Agent>

The releasing agent is not particularly restricted, and it may be appropriately selected according to purpose. Examples thereof include waxes.

Examples of the waxes include low-molecular-weight polyolefin waxes, synthetic hydrocarbon waxes, natural waxes, petroleum waxes, higher fatty acids and metal salts thereof, higher fatty acid amides, and various modified waxes thereof. These may be used alone or in combination of two or more.

Examples of the low-molecular-weight polyolefin waxes include low-molecular-weight polyethylene waxes and low-molecular-weight polypropylene waxes. Examples of the synthetic hydrocarbon waxes include a Fischer-Tropsch wax. Examples of the natural waxes include beeswax, a carnauba wax, a candelilla wax, a rice wax and a montan wax. Examples of the petroleum waxes include a paraffin wax and a microcrystalline wax. Examples of the higher fatty acids include stearic acid, palmitic acid and myristic acid.

A melting point of the releasing agent is not particularly restricted, and it may be appropriately selected according to purpose. Nonetheless, for example, it is preferably 40° C. to 160° C., more preferably 50° C. to 120° C., and further more preferably 60° C. to 90° C. When the melting point of the releasing agent is less than 40° C., there are cases where the toner has decreased heat-resistant storage stability. On the other hand, when the melting point of the releasing agent exceeds 160° C., there are cases where cold offset (low-temperature offset) is likely to occur during fixing at a low temperature. Also, there are cases where paper winding to a fixing apparatus occurs. Here, cold offset is that a part of a toner image is removed by electrostatic adsorption because a toner does not sufficiently melt near an interface between the toner and a fixing medium (e.g., paper) in a heat-roller fixing method, for example.

An amount of the releasing agent added with respect to 100 parts by mass of the pressure plastic material is preferably 1 part by mass to 20 parts by mass, more preferably 3 parts by mass to 15 parts by mass. When the amount of the releasing agent added is less than 1 part by mass, there are cases where a sufficient effect of the releasing agent cannot be obtained. On the other hand, when the amount of the releasing agent added exceeds 20 parts by mass, there are cases where the toner has decreased heat-resistant storage stability.

A content of the releasing agent is not particularly restricted but is preferably 1 part by mass to 20 parts by mass, more preferably 3 parts by mass to 15 parts by mass, with respect to 100 parts by mass of the pressure plastic material.

### <Other Components>

Other components may be added to the toner of the present embodiments according to necessity. Specifically, it is possible to add materials such as colorant, surfactant, dispersant and charge controlling agent.

### <<Colorant>>

The colorant is not particularly restricted, and it may be appropriately selected from heretofore known pigments and dyes according to purpose.

Examples of the colorant include carbon black, nigrosine dye, iron black, naphthol yellow S, Hansa Yellow (10G, 5G, G), Cadmium Yellow, yellow iron oxide, yellow ocher, chrome yellow, titanium yellow, polyazo yellow, Oil Yellow, Hansa Yellow (GR, A, RN, R), Pigment Yellow L, Benzidine Yellow (G, GR), Permanent Yellow (NCG), Vulcan Fast Yellow (5G, R), tartrazine lake, quinoline yellow lake, Anthrazane Yellow BGL, isoindolinone yellow, colcothar, red lead, lead vermilion, cadmium red, Cadmium Mercury Red, antimony vermilion, Permanent Red 4R, Para Red, Fiser Red, para-chloro-ortho-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, Perynone Orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, phthalocyanine green, Anthraquinone Green, titanium oxide, zinc oxide and lithopone.

Examples of the dyes include C.I. SOLVENT YELLOW (6, 9, 17, 31, 35, 100, 102, 103, 105), C.I. SOLVENT ORANGE (2, 7, 13, 14, 66), C.I. SOLVENT RED (5, 16, 17, 18, 19, 22, 23, 143, 145, 146, 149, 150, 151, 157, 158), C.I. SOLVENT VIOLET (31, 32, 33, 37), C.I. SOLVENT BLUE (22, 63, 78, 83 to 86, 191, 194, 195, 104), C.I. SOLVENT GREEN (24, 25) and C.I. SOLVENT BROWN (3, 9).

Also, commercially available dyes may be used. Examples of the commercially available dyes include: AIZEN SOT dyes including YELLOW-1, 3, 4, ORANGE-1, 2, 3, SCARLET-1, RED-1, 2, 3, BROWN-2, BLUE-1, 2, VIOLET-1, GREEN-1, 2, 3, BLACK-1, 4, 6, 8, manufactured by Hodogaya Chemical Co., Ltd.; SUDAN dyes including YELLOW-146, 150, ORANGE-220, RED-290, 380, 460, BLUE-670, manufactured by BASF; DIARESIN YELLOW-3G, F, H2G, HG, HC, HL, ORANGE-HS, G, RED-GG, S, HS, A, K, H5B, VIOLET-D, BLUE-J, G, N, K, P, H3G, 4G, GREEN-C, BROWN-A, manufactured by Mitsubishi Chemical Corporation; OIL COLORS including OIL YELLOW 3G, GG-S, #105, ORANGE PS, PR, #201, SCARLET #308, RED 5B, BROWN-GR, #416, GREEN-BG, #502, BLUE-BOS, IIN, BLACK-HBB, #803, EB, EX, manufactured by Orient Chemical Industries Co., Ltd.; SUMIPLAST BLUE GP, OR, RED FB, 3B, YELLOW FL7G, GC, manufactured by Sumitomo Chemical Co., Ltd.; and KAYALON POLYESTER BLACK EX-SF300, KAYASET RED-B, BLUE A-2R, manufactured by Nippon Kayaku Co., Ltd.

A content of the colorant is not particularly restricted, and it may be appropriately selected according to a desired degree of coloring. Nonetheless, it is preferably 1 part by mass to 50 parts by mass with respect to 100 parts by mass of the pressure plastic material. Here, the above-described colorant may be used alone or in combination of two or more.

### <<Surfactant>>

The toner of the present embodiments preferably includes a surfactant in the raw material. The surfactant in the present embodiments refers to a compound having a part with an affinity to a first compressive fluid described later and a part with an affinity to a toner in one molecule.

The surfactant is not particularly restricted, and it may be appropriately selected according to purpose. Nonetheless, when the first compressive fluid described later is carbon dioxide, it is preferable to use a compound containing a carbon dioxide-philic group, including: fluorosurfactant and silicone surfactant; and a compound containing a bulky functional group such as carbonyl group, hydrocarbon group and propylene oxide group. Among the above-described surfactants, it is preferable to use the fluorosurfactant, the silicone surfactant, the carbonyl group-containing compound and the polyethylene glycol (PEG) group-containing compound. Here, these surfactants may be in a form of an oligomer or a polymer.

As the fluorosurfactant, a compound containing a perfluoroalkyl group having 1 to 30 carbon atoms may be favorably used. Among these, it is preferable to use a high-molecular fluorosurfactant in view of surfactant performance, and charging performance and durability performance as a toner. Here, examples of a structural unit of the fluorosurfactant are shown in Formula (1-1) and Formula (1-2).

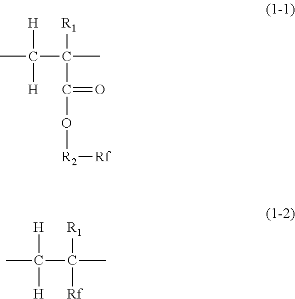

In Formula (1-1) and Formula (1-2), R₁ each independently represents a hydrogen atom or a lower alkyl group having 1 to 4 carbon atoms (e.g., methyl group, ethyl group, propyl group, isopropyl group, n-butyl group, sec-butyl group, tert-butyl group and so on).

In Formula (1-1), R₂ represents an alkylene group (e.g., methylene group, ethylene group, propylene group, isoprene group, 2-hydroxypropylene group, butylene group, 2-hydroxybutylene group and so on).

In Formula (1-1) and Formula (1-2), Rf represents a perfluoroalkyl group or a perfluoroalkenyl group having 1 to 30 carbon atoms.

Among those described, it is preferable to use a fluorosurfactant including: a hydrogen atom or a methyl group as R₁; a methylene group or an ethylene group as R₂; and a perfluoroalkyl group having 7 to 10 carbon atoms as Rf.

Here, by bonding a plurality of the structural units of Formula (1-1) and Formula (1-2), an oligomer or a polymer is formed. In this case, a homopolymer, a block copolymer, a random copolymer and so on may be formed according to affinity with the toner. Each end of the oligomer or the polymer is not particularly restricted, but it is usually a hydrogen atom.

The silicone surfactant is not particularly restricted as long as it is compound containing a siloxane bond, and it may be a low-molecular compound or a polymer compound. Among these, it is preferable to use a compound containing a polydimethylsiloxane (PDMS) group represented by Formula (2). Here, the silicone surfactant of the present embodiments may have a form of a homopolymer, a block copolymer, a random copolymer and so on depending on affinity with the toner.

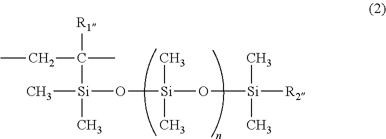

In Formula (2), R_{1″} represents a hydrogen atom or a lower alkyl group having 1 to 4 carbon atoms; n represents a number of repetitions; R_{2″} represents a hydrogen atom, a hydroxyl group or an alkyl group having 1 to 10 carbon atoms.

The carbonyl group-containing compound is not particularly restricted, and it may be appropriately selected according to purpose. Examples thereof include aliphatic polyester, polyacrylate and acrylic resin.

The PEG group-containing compound is not particularly restricted, and it may be appropriately selected according to purpose. Examples thereof include polyethylene glycol (PEG) group-containing polyacrylate and polyethylene glycol resin.

The above-described surfactant of the present embodiments may be produced by polymerizing a vinyl monomer such as Rf group-containing vinyl monomer, PDMS group-containing vinyl monomer and PEG group-containing vinyl monomer or by copolymerizing these vinyl monomers with other vinyl monomers. Examples of the vinyl monomer include a styrene monomer, an acrylate monomer and a methacrylate monomer. Here, commercial products of these vinyl monomers may be used.

Also, as the surfactant, a compound including an Rf group, a PDMS group or a PEG group as a main chain of the oligomer or the polymer and a COOH group, a OH group, an amino group, a pyrrolidone skeleton introduced as a side chain may be used.

The fluorine-containing surfactant is synthesized, for example, by polymerizing a fluorine-containing vinyl monomer in a fluorine-containing solvent such as HCFC225. Also, the fluorine-containing vinyl monomer may be polymerized with supercritical carbon dioxide as the solvent in place of HCFC225. Here, various raw materials having a structure similar to a compound containing a perfluoroalkyl group are commercially available (see a catalog of AZmax Co., for example), and various surfactants may be obtained by using them. As a specific method for producing a surfactant, a method described in Handbook of Fluorine Resins (edited by Takaomi Satokawa, published by Nikkan Kogyo Shimbun, Ltd., p. 730 to p. 732) and so on may be used.

Also, the silicone surfactant may be produced by polymerizing a vinyl polymerizable monomer as a raw material thereof. As a solvent for polymerization, a supercritical fluid (supercritical carbon dioxide) may be used. Also, various materials having a structure similar to polydimethylsiloxane are commercially available (see a catalog of AZmax Co., for example), and the silicone surfactant may be obtained by using them. Among these, a silicon-containing compound (product name: MONASIL-PCA, manufactured by Croda International Plc.) is preferably used for achieving favorable granulation property.

A content of the surfactant with respect to the raw materials of the toner is preferably 0.01% by mass to 30% by mass, more preferably 0.1% by mass to 20% by mass.

### <<Dispersant>>

The dispersant is not particularly restricted, and it may be appropriately selected according to purpose. For example, organic fine particles, inorganic fine particles and so on may be used. Among these, acrylic-modified inorganic fine particles, silicone-modified inorganic fine particles, fluorine-modified inorganic fine particles, fluorine-containing organic fine particles, silicone-based organic fine particles and so on are preferable, and the acrylic-modified inorganic fine particles are more preferable. Also, as the dispersant, those which melts in a compressive fluid described later are preferable.

Examples of the organic fine particles include silicone-modified and fluorine-modified acrylic fine particles which are insoluble in a supercritical fluid. Examples of the inorganic fine particles include: polyvalent metal salts of phosphoric acid such as calcium phosphate, magnesium phosphate, aluminum phosphate and zinc phosphate; carbonates such as calcium carbonate and magnesium carbonate; inorganic salts such as calcium metasilicate, calcium sulfate and barium sulfate; inorganic oxides such as calcium hydroxide, magnesium hydroxide, aluminum hydroxide, silica, titanium oxide, bentonite and alumina. Among these, the silica is preferable.

Examples of the acrylic-modified inorganic fine particles include those obtained by modifying a residual OH group existing on a surface of inorganic fine particles with a silane coupling agent containing a fluorine atom. As a specific example, an example of modifying a surface of silica using 3-(trimethoxysilyl)propyl acrylate as the silane coupling agent.

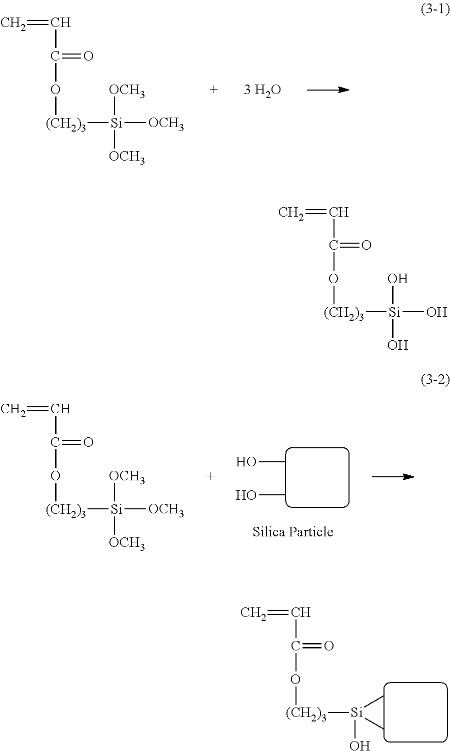

The acrylic-modified silicas obtained in the examples of the reaction formulae described above have high affinity to supercritical carbon dioxide on a silica side and high affinity to the toner on an acrylate side. Here, the present modification example is one example, and surface modification of silica may be carried out using other methods.

The following shows specific examples of the silane coupling agent containing a fluorine atom.

### (4-1) CF₃(CH₂)₂SiCl₃;

### (4-2) CF₃(CF₂)₅SiCl₃;

### (4-3) CF₃(CF₂)₅(CH₂)₂SiCl₃;

### (4-4) CF₃(CF₂)₇(CH₂)₂SiCl₃;

### (4-5) CF₃(CF₂)₇CH₂CH₂Si(OCH₃)₃;

### (4-6) CF₃(CF₂)₇(CH₂)₂Si(CH₃)Cl₂;

### (4-7) CF₃(CH₂)₂Si(OCH₃)₃;

### (4-8) CF₃(CH₂)₂Si(CH₃)(OCH₃)₂;

### (4-9) CF₃(CF₂)₃(CH₂)₂Si(OCH₃)₃;

### (4-10) CF₃(CF₂)₅CONH(CH₂)₂Si(OC₂H₅)₃;

### (4-11) CF₃(CF₂)₄COO(CH₂)₂Si(OCH₃)₃;

### (4-12) CF₃(CF₂)₇(CH₂)₂Si(OCH₃)₃;

### (4-13) CF₃(CF₂)₇(CH₂)₂Si(CH₃)(OCH₃)₂;

### (4-14) CF₃(CF₂)₇SO₂NH(CH₂)₃Si(OC₂H₅)₃;

### (4-15) CF₃(CF₂)₈(CH₂)₂Si(OCH₃)₃.

A content of the dispersant is preferably 0.1% by mass to 30% by mass with respect to the raw materials of the toner. Also, it is preferable that one type of the above-described dispersant is used alone, but in view of controlling toner particle diameter and toner charging property, other surfactants may be used in combination therewith.

### <<Charge Controlling Agent>>

The charge controlling agent is not particularly restricted, and it may be appropriately selected according to purpose. Nonetheless, since use of a colored charge controlling agent may change color tone, it is preferable to use a charge controlling agent close to colorless or white.

Examples of the charge controlling agent include nigrosine dyes, triphenylmethane dyes, chromium-containing metal complex dyes, molybdic acid chelate pigments, rhodamine dyes, alkoxy amines, quaternary ammonium salt (including fluorine-modified quaternary ammonium salts), alkyl amides, elemental phosphorus or phosphorus compound, elemental tungsten or tungsten compounds, fluorine surfactants, metal salts of salicylic acid and metal salts of salicylic acid derivatives. Among the above-mentioned charge controlling agents, it is preferable to use the metal salts of salicylic acid and the metal salts of salicylic acid derivatives. These may be used alone or in combination of two or more.

A metal used for the metal salts is not particularly restricted, and it may be appropriately selected according to purpose. Nonetheless, examples thereof include aluminum, zinc, titanium, strontium, boron, silicon, nickel, iron, chrome and zirconium.

Commercial products may be used as the charge controlling agent. Examples of the commercial products of the charge controlling agent include: BONTRON P-51 as a quaternary ammonium salt, E-82 as an oxynaphthoic acid metal complex, E-84 as a salicylic acid metal complex, E-89 as a phenol condensate (all manufactured by Orient Chemical Industries Co., Ltd.); TP-302, TP-415 as quaternary ammonium salt molybdenum complexes, TN-105 as a salicylic acid metal complex (all manufactured by Hodogaya Chemical Co., Ltd.); COPY CHARGE PSY VP2038 as a quaternary ammonium salt, COPY BLUE PR as a triphenylmethane derivative, COPY CHARGE NEG VP2036, COPY CHARGE NX VP434 as quaternary ammonium salts (all manufactured by Clariant (Japan) K.K.); LRA-901, LR-147 as a boron complex (manufactured by Carlit Japan Co., Ltd.), quinacridone, azo pigments, other polymeric compound containing a functional group such as sulfonic acid group, carboxyl group and quaternary ammonium salt.

A content of the charge controlling agent is not particularly restricted, and it may be appropriately selected according to purpose. Nonetheless, with respect to 100 parts by mass of the above-described pressure plastic material, it is preferably 0.5 parts by mass to 5 parts by mass, more preferably 1 part by mass to 3 parts by mass. When the content of the charge controlling agent is less than 0.5 parts by mass, there are cases where the toner has degraded charge properties. On the other hand, when the content of the charge controlling agent exceeds 5 parts by mass, charging property of the toner is excessive and reduces an effect of a main charge controlling agent. This increases an electrostatic attraction with a developing roller, which may result in decrease in fluidity of a developer or decrease in image density.

### <<Other Additives>>

The toner of the present embodiments may include other additives. Examples of the other additives include a fluidity improving agent and cleanability improving agent. The fluidity improving agent refers to those which improve hydrophobicity by surface treatment of the toner and have a function of preventing degradation of fluidity properties or charge properties under high-humidity.

Examples of the fluidity improving agent include a silane coupling agent, a silylating agent, a silane coupling agent having a fluorinated alkyl group, an organic titanate coupling agent, an aluminum-based coupling agent, a silicone oil and a modified silicone oil.

The cleanability improving agent refers to a compound having a function of removing a developer remaining on a photoconductor or a primary transfer medium after transfer.

Examples of the cleanability improving agent include: fatty acid metal salts such as zinc stearate, calcium stearate and stearic acid; and polymeric particles produced by soap-free emulsion polymerization of polymethyl methacrylate fine particles and polystyrene fine particles.

The polymeric particles having a relatively narrow particle size distribution is preferable, and those having a volume-average particle diameter of 0.01 μm to 1 μm are preferable.

### Method for Producing Toner

### First Embodiment

A method for producing a toner of a first embodiment of the present invention is a method for producing a toner, including:

a mixing step, wherein a pressure plastic material and a releasing agent are continuously supplied and joined to continuously form a mixture of the pressure plastic material and the releasing agent, and the mixture is continuously supplied to a next step;

a melting step, wherein a first compressive fluid and the mixture are brought into contact with each other to melt the mixture; and

a granulating step, wherein a melt obtained in the melting step is jetted for granulation,

wherein the toner is a toner including a pressure plastic material and a plurality of particulate releasing agents, and the particulate releasing agents forming domain phases are dispersed in the pressure plastic material forming a continuous phase.

It further includes other steps according to necessity.

The method for producing a toner may be favorably carried out by using, for example, apparatuses for producing particles 1, 2.

### Second Embodiment

A method for producing a toner of a second embodiment of the present invention is a method for producing a toner, including:

a melting step, wherein a pressure plastic material and a releasing agent are brought into contact with a first compressive fluid at a temperature below a melting point of the releasing agent to thereby melt the pressure plastic material; and

a granulating step, wherein a melt obtained in the melting step is jetted at a temperature below the melting point of the releasing agent for granulation,

wherein the toner is a toner including a pressure plastic material and a plurality of particulate releasing agents, and the particulate releasing agents forming domain phases are dispersed in the pressure plastic material forming a continuous phase.

It further includes other steps according to necessity.

The method for producing a toner may be favorably carried out by using, for example, apparatuses for producing particles 3, 4, 5.

It is preferable that the melting point of the releasing agent is higher than the glass transition temperature of the pressure plastic material.

In both the first embodiment and the second embodiment, the melt has a viscosity of preferably 500 mPa·s or less, more preferably 20 mPa·s or less.

Also, the granulating step preferably includes supplying a second compressive fluid to the melt obtained in the melting step while jetting the melt for granulation, and it is preferable that the second compressive fluid includes nitrogen.

### —Compressive Fluid—

Next, the compressive fluid used in the present embodiments is explained in reference to diagrams.

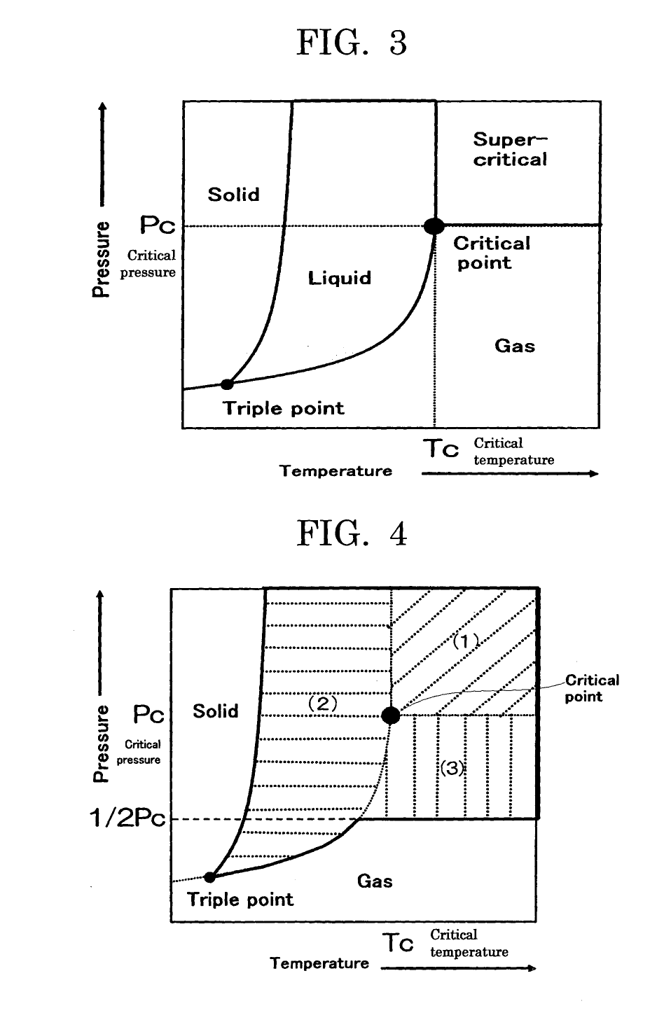

FIG. 3 illustrates an example of a phase diagram for explaining a state of a substance at a certain temperature and pressure condition. Also, FIG. 4 illustrates an example of a phase diagram for explaining the compressive fluid of the present embodiments.

The compressive fluid of the present embodiments refers to those having properties such as fast material transfer and heat transfer and low viscosity as well as properties that a density, a dielectric constant, a solubility parameter, free volume and so on changes continuously and greatly by varying a temperature and a pressure. In general, a compressive fluid has a small interfacial tension compared to an organic solvent, and it can follow and wet even minute undulations (surface).

Also, when it is used as a reaction field, the compressive fluid may be easily separated and removed from products such as toner by returning to a normal pressure and may be easily recovered and reused. Thus, in the method for producing the toner of the present embodiments, it is possible to reduce an impact on the environment during production compared to a conventional producing method which uses water or an organic solvent.

The “compressive fluid” in the present embodiments refers to a substance existing in a region (1), (2) or (3) of FIG. 4 in the phase diagram of FIG. 3. The substance in such regions is in a state of a very high density, and it is known to behave differently under a normal temperature and a normal pressure.

Here, the substance existing in the region (1) is a supercritical fluid. The supercritical fluid refers to a fluid that exists as a non-condensable high-density fluid in a temperature and/or pressure region beyond a limit (critical point) that a gas and a liquid can coexist, which does not condense upon compression.

Also, the substance existing in the region (2) is a liquid, and in the present embodiments, it denotes a liquefied gas obtained by compressing a substance in a state of gas at a normal temperature (25° C.) and a normal pressure (1 atm).

Further, the substance existing in the region (3) is a gas, and in the present embodiments, it denotes a high-pressure gas having a pressure of a half of the critical pressure (Pc) (½ Pc) or greater.

Examples of a material which may be used as the compressive fluid in the present embodiments include carbon monoxide, carbon dioxide, dinitrogen monoxide, nitrogen, air, oxygen, argon, helium, neon, krypton, methane, ethane, propane, 2,3-dimethylbutane, ethylene, ammonia, normal butane, isobutane, normal pentane, isopentane and chlorotrifluoromethane. These compressive fluids may be used alone or in combination of two or more.

In the present embodiments, the compressive fluid for melting the pressure plastic material (hereinafter, it is also referred to as a first compressive fluid) is not particularly restricted. Nonetheless, among the above-described compressive fluids, carbon dioxide is preferably used since it easily creates a supercritical state and is non-flammable and safe, and a toner having a hydrophobic surface may be obtained in producing a toner.

In a producing method of the present embodiments, apart from the first compressive fluid, a second compressive fluid may be used and supplied to the melt in jetting the melt.

The second compressive fluid is not particularly restricted, and the above-described compressive fluids may be used according to purpose. Nonetheless, it is a compressive fluid having a maximum inversion temperature of 800 K or less (e.g., oxygen, nitrogen), and it is preferably a compressive fluid including nitrogen. Here, including nitrogen means including nitrogen molecules, and examples thereof include air.

Nitrogen has a maximum inversion temperature of 620 K, and it has a low maximum inversion temperature compared to substances such as carbon dioxide (maximum inversion temperature of 1,500 K). Thereby, a temperature decrease based on the Joule-Thomson effect in reducing a pressure of nitrogen is small compared to a case where a pressure of carbon dioxide and so on is reduced. On the other hand, when a compressive fluid having a high maximum inversion temperature such as carbon dioxide is used as the second compressive fluid, there are cases where cooling by the Joule-Thomson effect becomes excessive when the melt is jetted. This solidifies the melt before it is atomized, and there are cases where fibrous or coalesced products get mixed. Also, when the cooling is excessive, the melt solidifies inside a nozzle which jets the melt. Thus, depending on a reaction time, there are cases where it is difficult to produce particles having a small particle diameter and small particle size distribution.

In the present embodiments, the compressive fluid may be used in combination with an entrainer (cosolvent). Examples of the entrainer include: alcohols such as methanol, ethanol and propanol; ketones such as acetone and methyl ethyl ketone; organic solvents such as toluene, ethyl acetate and tetrahydrofuran.

Also, in producing the toner of the present embodiments, in order to make it easier to control a solubility of the toner composition, other fluids may be used in combination with the above-described compressive fluids. Specific examples of the other fluids include methane, ethane, propane, butane and ethylene.

### First Embodiment

Hereinafter, one embodiment of the present invention is explained. In the method for producing the toner of the present embodiment, a releasing agent and a pressure plastic material are separately melted in advance, and then they are respectively supplied to a mixing device at a predetermined mass ratio in a continuous manner. The releasing agent and the pressure plastic material joined in the mixing device are immediately mixed to form a mixture. At this time, the obtained mixture is continuously supplied to a next step. In general, a releasing agent and a pressure plastic material have different specific gravities. Thus, when these are simultaneously melted in an identical container, there are cases where the releasing agent and the pressure plastic material separate in two phases. As a result, the resultant toner may not have a desired amount of the releasing agent.

[Apparatus for Producing Particles]

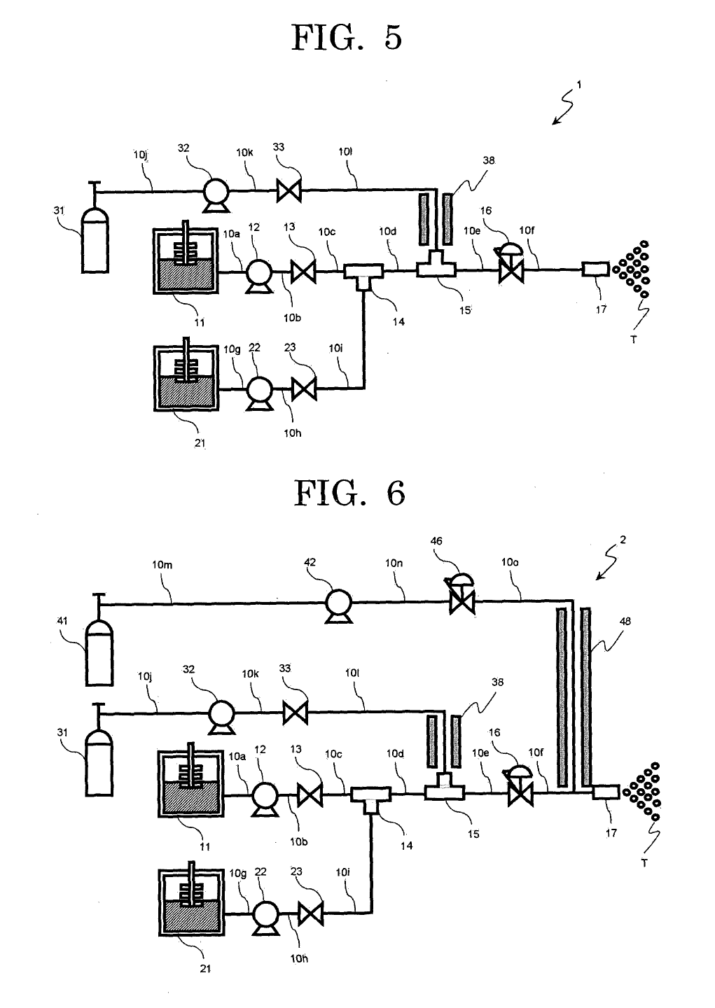

Next, in reference to FIG. 5, an apparatus for producing particles that may be used in a first embodiment is explained. FIG. 5 illustrates a schematic diagram of an apparatus for producing particles relating to one embodiment of the present invention.

In an apparatus for producing particles 1 in FIG. 5, a cell 11, a pump 12, a valve 13, a mixing device 14, a mixing device 15, a back-pressure valve 16 and a nozzle 17 are connected in recited order via ultrahigh-pressure pipes (10a, 10b, 10c, 10d, 10e and 10f).

Also, in the apparatus for producing particles 1, a cell 21, a pump 22 and a valve 23 are connected in recited order via ultrahigh-pressure pipes (10g and 10h), and the valve 23 is connected to the mixing device 14 via an ultrahigh-pressure pipe (10i).

Further, in the apparatus for producing particles 1, a cylinder 31, a pump 32 and a valve 33 are connected via ultrahigh-pressure pipes (10j and 10k), and the valve 33 is connected to the mixing device 15 via an ultrahigh-pressure pipe (10l). Also, a heater 38 is arranged, and it is possible to heat in the ultrahigh-pressure pipe 10l.

The cell 11 includes a temperature controller not shown as a function to heat a pressure plastic material which has been filled in the cell 11 in advance. Also, a stirring device is attached to the cell 11, and thereby, the pressure plastic material is stirred for uniform heating.

The pump 12 has a function of pumping the pressure plastic material in the cell 11 to a side of the mixing device 14. The valve 13 opens and closes a path between the pump 12 and the mixing device 14 to control a flow rate of the pressure plastic material.

The cell 21 includes a temperature controller not shown as a function to heat a releasing agent which has been filled in the cell 21 in advance. Also, a stirring device is attached to the cell 21, and thereby, the releasing agent is stirred for uniform heating.

The pump 22 has a function of pumping the releasing agent in the cell 21 to a side of the mixing device 15. The valve 23 opens and closes a path between the pump 22 and the mixing device 14 to control a flow rate of the releasing agent.

The mixing device 14 has a function of mixing the pressure plastic material supplied from the cell 11 and the releasing agent supplied from the cell 21 by continuously contacting them. Specific examples of the mixing device 14 include a heretofore known T-shaped joint, a swirl mixer including a swirl flow and a central collision-type mixer in which two liquids collide in a mixing unit.

The cylinder 31 is a pressure tight case for storing the first compressive fluid and supplying it in the mixing device 15. It is preferable to use air, nitrogen or carbon dioxide as the compressive fluid stored in the cylinder 31 for reasons such as cost and safety. Among these, it is more preferable to use carbon dioxide. Here, a material stored in the cylinder 31 may be in a state of gas or liquid, provided that it is subjected to a temperature control in the mixing device 15 to become a compressive fluid (first compressive fluid).

The pump 32 has a function of pumping the compressive fluid stored in the cylinder 31 to a side of the mixing device 15.

The valve 33 has a function of adjusting a flow rate of the compressive fluid by opening and closing a path between the pump 32 and the mixing device 15 (including a function of blocking).

The mixing device 15 has a function of mixing by continuously bringing the pressure plastic material including the releasing agent supplied from the mixing device 14 and the first compressive fluid supplied from the cylinder 31 into contact. The mixing device 15 is not particularly restricted as long as it is capable of mixing homogeneously the pressure plastic material including the releasing agent and the first compressive fluid. It may be the same mixing device as or a different mixing device from the mixing device 14.

The back-pressure valve 16 has a function of adjusting a flow rate or a pressure of a melt supplied from the mixing device 15 by opening and closing a path between the mixing device 15 and the nozzle 17 (including a function of blocking).

The nozzle 17 is not particularly restricted, but it is preferable to use a direct nozzle. A diameter of the nozzle 17 is not particularly restricted as long as a certain pressure is maintained during jetting. Nonetheless, the nozzle 17 having an excessively large diameter reduces the pressure during jetting and increases melt viscosity, and as a result, there are cases where obtaining fine particles becomes difficult. There are also cases where a larger supply pump is required in order to maintain the pressure. On the other hand, when the nozzle 17 has an excessively small nozzle diameter, there are cases where the melt is likely to clog in the nozzle 17. Because of the above viewpoints, the nozzle diameter of the nozzle 17 is preferably 500 μm or less, more preferably 300 μm or less, and further more preferably 100 μm or less. Also, the nozzle diameter of the nozzle 17 is preferably 5 μm or greater, more preferably 20 μm or greater, and further more preferably 50 μm or greater. Also, in order to prevent the nozzle 17 from clogging, it is possible to arrange a porous filter not shown between the back-pressure valve 16 and the nozzle 17.

Next, in reference to FIG. 6, another embodiment of the apparatus for producing particles of the first embodiment is explained. FIG. 6 illustrates a schematic diagram of an apparatus for producing particles relating to another embodiment of the present invention.

Here, in the explanation of the apparatus for producing particles 2 of FIG. 6, identical reference signs may be used with their descriptions omitted for units, mechanisms or devices which are in common with the apparatus for producing particles 1 in FIG. 5.

In an apparatus for producing particles 2, a cell 11, a pump 12, a valve 13, a mixing device 14, a mixing device 15, a back-pressure valve 16 and a nozzle 17 are connected in recited order via ultrahigh-pressure pipes (10a, 10b, 10c, 10d, 10e and 10f).

Also, in the apparatus for producing particles 2, a cell 21, a pump 22 and a valve 23 are connected in recited order via ultrahigh-pressure pipes (10g and 10h), and the valve 23 is connected to the mixing device 14 via an ultrahigh-pressure pipe (10i).

Further, in the apparatus for producing particles 2, a cylinder 31, a pump 32 and a valve 33 are connected via ultrahigh-pressure pipes (10j and 10k), and the valve 33 is connected to the mixing device 15 via an ultrahigh-pressure pipe (10l). Also, a heater 38 is arranged, and it is possible to heat in the ultrahigh-pressure pipe 10l.

Furthermore, in the apparatus for producing particles 2, a cylinder 41, a pump 42 and a back-pressure valve 46 are connected via ultrahigh-pressure pipes (10m and 10n), and the back-pressure valve 46 is connected to the ultrahigh-pressure pipe 10f via an ultrahigh-pressure pipes 10o. Also, a heater 48 is arranged, and it is possible to heat the ultrahigh-pressure pipes 10o.

The cylinder 41 is a pressure tight case for storing and supplying a second compressive fluid. It is preferable to use air, nitrogen, argon, helium or carbon dioxide as the second compressive fluid for reasons such as safety. Among these, it is preferable to use air, nitrogen or carbon dioxide in view of cost and so on. Here, a material stored in the cylinder 41 may be in a state of gas or liquid and turned into a compressive fluid in a middle of a path.

The pump 42 has a function of pumping the second compressive fluid stored in the cylinder 41 to a side of the nozzle 17. The back-pressure valve 46 has a function of adjusting a flow rate of the second compressive fluid by opening and closing a path between the pump 42 and the nozzle 17 (including a function of blocking). At this time, an accumulator not shown may be arranged between the pump 42 and the back-pressure valve 46.

The compressive fluid heated by the heater 48 is cooled at an exit of the nozzle 17 by the Joule-Thomson effect. Thus, it is preferable that the compressive fluid is sufficiently heated by the heater 48 and is in a state of a supercritical fluid (1) illustrated in the phase diagram in FIG. 4.

In the above-mentioned apparatus for producing particles 2, while the second compressive fluid is supplied to a melt of the raw materials including the first compressive fluid obtained in the mixing device 15, the melt is jetted from the nozzle 17. In this case, a viscosity of a melt of the pressure plastic material may be decreased by a pressure of the second compressive fluid, and accordingly, a process design having high processability becomes possible. Thereby, particles may be efficiently produced under conditions of a small amount of the releasing agent component added to the raw materials and a high molecular weight of the pressure plastic material.

Here, in the above apparatuses for producing particles (1, 2), heretofore known fittings and so on are used as the mixing devices (14 and 15). However, for example, when fluids having different viscosities such as melt resin and compressive fluid are mixed in a conventional static mixer, it is difficult in many cases to mix the both fluids homogeneously. Accordingly, the static mixer of the present embodiments preferably includes a mixing element in a tubular housing. This element does not include moving parts, and a plurality of baffle plates are arranged along an axial direction of the tube as a center. When such a static mixer is used, a fluid receives splitting, conversion and reversal actions by an element installed in the tube in the course of moving in a tubular housing, and thereby the fluid is mixed. Also, in a static mixer of another embodiment, it is possible to use a plurality of elements formed of a honeycomb plate composed of polygonal chambers superposed and aligned. In this type of a static mixer, a fluid sequentially moves outward from a central portion of the tube and to the central portion from the outside in the chambers inside the tube. Thereby, the fluid receives splitting, conversion and reversal actions and is mixed. However, when a high-viscosity fluid such as resin and a low-viscosity fluid such as compressive fluid are passed in these static mixers, the low-viscosity fluid does not receive a mixing action by the element and passes through a gap between the element in the tube and the tubular housing. As a result, the fluids may not be homogeneously mixed. As a workaround for this poor mixing, it is possible to increase complexity of the element structure or increase the length of the mixers. However, these workarounds are not effective in preventing the phenomenon of the low-viscosity fluid passing through, causing problems such as increased pressure loss during mixing, increased apparatus size and increased cleaning effort.

### [Method for Producing a Toner]

Next, a method for producing a toner using the apparatus for producing particles (1, 2) relating to one embodiment of the present invention is explained.

The method for producing the toner of the present embodiment is a method for producing a toner, including:

a mixing step, wherein a pressure plastic material and a releasing agent are continuously supplied and joined to continuously form a mixture including the pressure plastic material and the releasing agent, and the mixture is continuously supplied to a next step (i.e., to a melting step),

a melting step, wherein the first compressive fluid and the mixture are brought into contact with each other to melt the mixture,

a granulating step, wherein a melt obtained in the melting step is jetted and granulated.

wherein the toner includes: a binder resin including the pressure plastic material; and the releasing agent,

### (Mixing Step)

When the apparatus for producing particles (1, 2) is used, in mixing step, first, raw materials such as pressure plastic material and other materials (e.g., colorant) are filled in the cell 11. When the other materials such as colorant is included as the raw materials, it is preferable that these components are mixed in a mixer and melt-kneaded by a roller mill in advance and then filled in the cell 11.

The releasing agent is filled in the cell 21.

Next, the cell 11 is sealed. The raw materials are stirred and heated by a stirring device in the cell 11, and the pressure plastic material is melted. A temperature in the cell 11 is not particularly restricted as long as the pressure plastic material melts at the temperature.

Similarly, the cell 21 is sealed. The releasing agent is stirred and heated by a stirring device in the cell 21, and the releasing agent is melted. A temperature in the cell 21 is not particularly restricted as long as the releasing agent melts at the temperature.

Next, the pump 12 is actuated, and the valve 13 is opened. Similarly, the pump 22 is actuated, and the valve 23 is opened. By these actions, the pressure plastic material supplied from the cell 11 and the releasing agent supplied from the cell 21 are continuously in contact in the mixing device 14 and homogeneously mixed.

Here, the releasing agent may be melt-kneaded with the other raw materials in advance and filled in the cell 11, but in this case, the pressure plastic material and the releasing agent may split in the cell 11 depending on properties thereof. Thus, in the present embodiment, the pressure plastic material and the releasing agent are supplied using the separate cells, and thereby it is ensured that a certain amount of the releasing agent is incorporated in the toner.

### (Melting Step by Contacting Compressive Fluid)

Next, the melting step in which the raw materials such as pressure plastic material swell as well as are plasticized, semi-liquefied and liquefied by contacting the compressive fluid is explained.

When the apparatus for producing particles (1, 2) is used, the first compressive fluid stored in the cylinder 31 is pressurized by actuating the pump 32, and the valve 33 is opened. Thereby, the first compressive fluid is supplied in the mixing device 15. Here, in the present embodiment, a carbon dioxide cylinder is used as the cylinder 31.

The supplied first compressive fluid is heated in the ultrahigh-pressure pipes 10l by the heater 38. A preset temperature of the heater 38 is not particularly restricted as long as the supplied carbon dioxide becomes a compressive fluid at the temperature, but it is preferably a temperature below the melting point of the releasing agent.

A mixture of the releasing agent and the pressure plastic material supplied from the mixing device 14 and the first compressive fluid supplied from the cylinder 31 are subjected to continuous contact in the mixing device 15 for homogeneous mixing. Thereby, the mixture melts.

A melt obtained by melting the mixture has a viscosity of preferably 500 mPa·s or less.

In an embodiment of using the apparatus for producing particles (1, 2), the pressure plastic material and the compressive fluid may be mixed with the viscosity difference between them reduced as much as possible by melting the pressure plastic material in advance in the cell 11. Accordingly, it is possible to obtain a more homogeneous melt. Here, in the present embodiment, the pressure plastic material is melted by an application of heat, but it is possible to melt the pressure plastic material by application of pressure. It is also possible to melt the pressure plastic material by application of both heat and pressure.

### (Granulating Step and Granulation Unit)

Next, the granulating step in which the melt obtained in the melting step is jetted to produce particles (toner in the present embodiment) is explained.

The granulating step is a step of granulation by jetting the melt of the pressure plastic material, and it is carried out by the granulation unit.

There are a RESS method (Rapid Expansion of Supercritical Solution) and a PGSS method (Particles from Gas Saturated Solution) as a method to granulate fine particles using carbon dioxide as the compressive fluid, and the PGSS method is used in the present embodiment.

The RESS method is a rapid expansion method, where a material as a solute is dissolved to saturation in a supercritical fluid under a high pressure, and fine particles are precipitated by using a rapid decline in the solubility by rapid decompression from a nozzle.

In the RESS method, a pressure of the supercritical fluid instantly decreases to atmospheric pressure at the nozzle exit, and in accordance with this, a saturation solubility of the solute decreases. That is, a large degree of supersaturation achieved within an extremely short time generates many fine agglomeration nuclei, which precipitate with little growth. As a result, submicron particles may be obtained.

On the other hand, in the PGSS method, the supercritical fluid is dissolved to saturation in a melt solution of the pressure plastic material (operated at a concentration below saturation solubility in the present embodiment), and rapid decompression is carried out by spraying the liquid through a nozzle. Solubility of the supercritical fluid dissolved in the melt solution rapidly decreased due to the decompression. It becomes bubbles to split the melt solution, and at the same time, fine particles are generated by a cooling effect due to adiabatic expansion.

When the apparatus for producing particles 1 is used, by opening the back-pressure valve 16, the melt obtained by contacting the compressive fluid and the mixture in the mixing device 15 is jetted from the nozzle 17. At this time, in order to maintain constant temperatures in the cells 11, 21 and the mixing devices 14, 15, the pumps (12, 22, 32) and temperature controllers not shown are controlled. Here, a pressure in the mixing device 15 is not particularly restricted.

The melt jetted from the nozzle 17 becomes particles, followed by solidification. Here, when the apparatus for producing particles 1 is used, the melt obtained by the mixture and the compressive fluid continuously contacting in the mixing device 15 is supplied to the nozzle 17, and thus continuous granulation of particles is possible.

When the apparatus for producing particles 2 is used, by actuating the pump 42 and opening the back-pressure valve 46, the second compressive fluid stored in the cylinder 41 is supplied to the nozzle 17. In the present embodiment, a nitrogen cylinder is used as the cylinder 41.

A pressure of the supplied second compressive fluid is not particularly restricted, and it may be appropriately selected according to purpose. Nonetheless, it is preferably 1 MPa or greater, more preferably 10 MPa to 200 MPa, and particularly preferably 31 MPa to 100 MPa. When the pressure applied to the second compressive fluid is less than 1 MPa, there are cases where a plasticizing effect sufficient for granulation of the pressure plastic material cannot be obtained. On the other hand, an upper limit of the pressure is not particularly restricted, but an equipment cost increases with the higher pressure.

The supplied second compressive fluid is heated in the ultrahigh-pressure pipes 10o by the heater 48. A preset temperature of the heater 48 is not particularly restricted as long as it is a temperature at which the supplied nitrogen becomes a compressive fluid and a temperature below the melting point of the releasing agent.

Next, by actuating the back-pressure valve 16, the melt of the pressure plastic material is supplied from the mixing device 15 to the nozzle 17. Thereby, with the second compressive fluid supplied to the melt, the melt may be jetted from the nozzle 17 to atmospheric pressure by a pressure difference.

In an embodiment of supplying the second compressive fluid, it is preferable that the viscosity of the melt is further reduced due to a decreased solid content concentration of the jetted melt. As a result, not only the jetted melt is controlled to have a constant temperature but also the jet speed (exit linear velocity) increases, and a shear force on the melt increases due to the improved exit linear velocity. Also, by using nitrogen as the second compressive fluid, the nozzle 17 is less likely to clog because a temperature decrease due to the Joule-Thomson effect due to a pressure change near the nozzle 17 is relaxed.

The melt jetted from the nozzle 17 becomes particles, followed by solidification. In this case, by a synergy of the reduced viscosity of the melt and reduced solid content concentration, uniform fine particles without coalescence may be produced over a long period of time. Also, a shape of the produced particles is uniformly stabilized.

### Second Embodiment

Next, a second embodiment is explained. The releasing agent used in the second embodiment has a melting point higher than a glass transition temperature of the above-described pressure plastic material.

By the melting point of the releasing agent higher than the glass transition temperature of the pressure plastic material, the releasing agent stays as a solid under conditions where the pressure plastic material is plasticized.

Also, since the releasing agent is encapsulated in the produced particles (toner in the present embodiment), those skilled in the art may usually employ a releasing agent granulated to an appropriate size according to a size of the toner to be produced. A method for producing particles of the releasing agent is not particularly restricted, and it may be appropriately selected according to purpose. Examples thereof include the RESS method and the PGSS method.

When the particles of the releasing agent are produced by the RESS (Rapid Expansion of Supercritical Solution) method, a small amount of the releasing agent is dissolved in a large amount of the supercritical carbon dioxide, and thereby the releasing agent is in a condition for jet granulation. That is, since carbon dioxide occupies the vast majority to begin with, the obtained releasing agent has a low viscosity. On the other hand, when the particles of the releasing agent are produced by the PGSS (Particles from Gas Saturated Solution) method, the releasing agent is contacted sufficiently by the supercritical carbon dioxide to dissolve the carbon dioxide and to plasticize the releasing agent. Thereby, the viscosity is reduced for jet granulation, and the releasing agent is subjected to jet granulation. Thus, for both the RESS method and the PGSS method, the conditions for sufficient contact of carbon dioxide and the releasing agent reduce the viscosity of the releasing agent, which become implementing conditions for jet granulation of the releasing agent.

On the other hand, in the method of producing a toner of present embodiment, the compressive fluid (e.g., supercritical carbon dioxide) is contacted by a material including the releasing agent fine particles (e.g., 5% by mass with respect to the raw materials) in a large amount of the pressure plastic material (e.g., polyester resin): Thus, the releasing agent fine particles in a solid state are not contacted by the supercritical carbon dioxide to an extent that is plasticized.

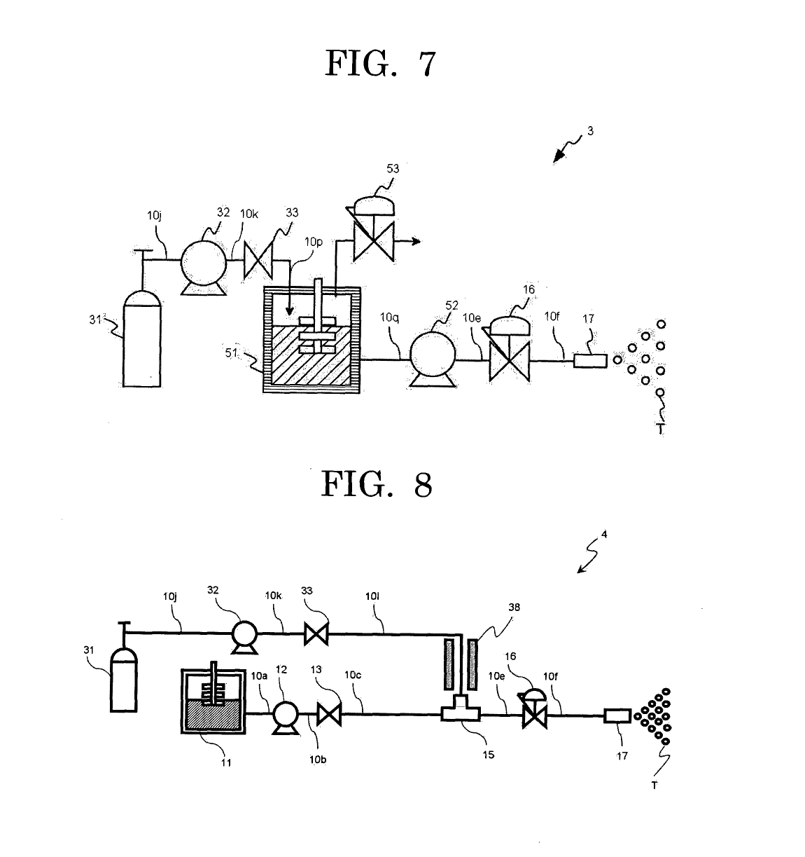

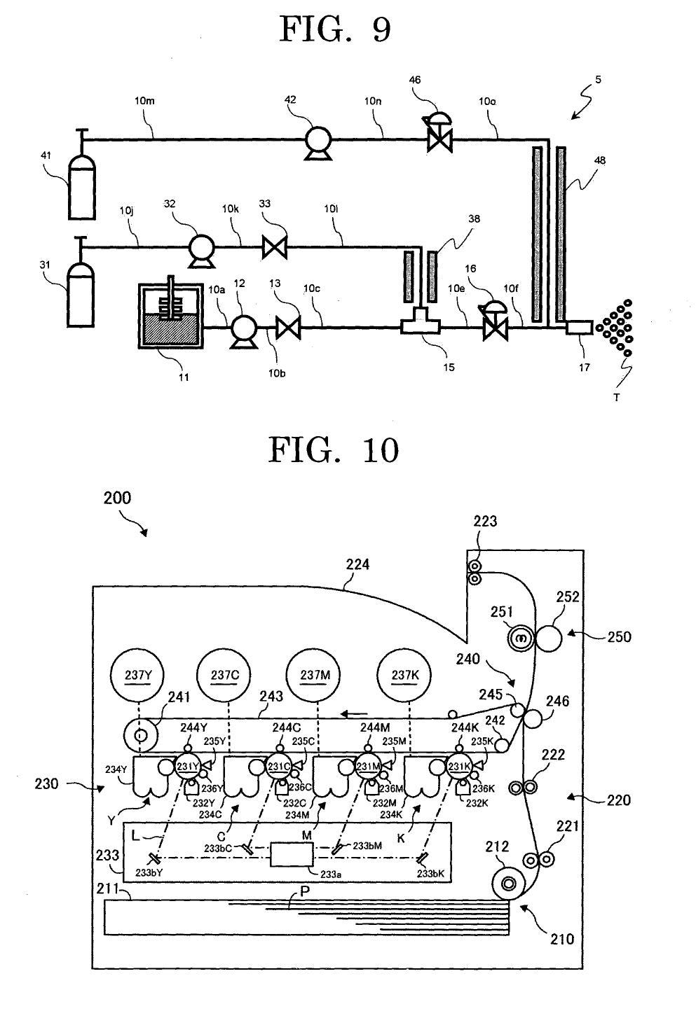

Next, in reference to FIG. 7 to FIG. 9, an apparatus for producing particles that may be used for the second embodiment is explained. FIG. 7 illustrates a schematic diagram of an apparatus for producing particles relating to yet another embodiment of the present invention. Also, FIG. 8 illustrates a schematic diagram of an apparatus for producing particles relating to yet another embodiment of the present invention. Further, FIG. 9 illustrates a schematic diagram of an apparatus for producing particles relating to yet another embodiment of the present invention.

In FIG. 7, an apparatus for producing particles 3 includes a cylinder 31, a pump 32, a valve 33, a high-pressure cell 51, a pump 52, a back-pressure valve 16 and a nozzle 17 connected by ultrahigh-pressure pipes (10j, 10k, 10p, 10q, 10e and 10f).

The cylinder 31 is a pressure tight case for storing and supplying a first compressive fluid. Here, the cylinder 31 may store a gas or a solid which is heated or pressurized in the high-pressure cell 51 to become a compressive fluid in a course of being supplied to the high-pressure cell 51. In this case, in the high-pressure cell 51, the gas or the solid stored in the cylinder 31 becomes any one of the states (1), (2) and (3) in the phase diagram of FIG. 4 due to heating or pressurization.

The pump 32 is an apparatus which pumps the compressive fluid stored in the cylinder 11 to a side of the high-pressure cell 51. The valve 33 is an apparatus having a function of adjusting a flow rate of the compressive fluid by opening and closing a path between the pump 32 and the high-pressure cell 51 (including a function of blocking).

The high-pressure cell 51 includes a temperature controller, and it brings the compressive fluid supplied via the valve 33 and the pressure plastic material filled in the high-pressure cell 51 in advance into contact at a predetermined temperature, thereby to melt the pressure plastic material. Here, a back-pressure valve 53 is usually attached to the high-pressure cell 51, by opening and closing this, a pressure in the high-pressure cell 51 may be adjusted. Also, a stirring device is attached to the high-pressure cell 51, thereby to stir and mix the compressive fluid and the pressure plastic material.

The pump 52 is an equipment to pump the melt in the high-pressure cell 51 to a side of the nozzle 17. The back-pressure valve 16 may open and close a path between the pump 52 and the nozzle 17 to adjust a flow rate of the melt obtained by melting the pressure plastic material. The nozzle 17 is installed at an end of the ultrahigh-pressure pipes 10f, and it can jet the melt.

Types of the nozzle 17 are particularly restricted, but a direct nozzle is preferably used. A diameter of the nozzle 17 is not particularly restricted as long as it can maintain a certain pressure during jetting. However, if it is excessively large, the pressure during jetting is too low, which causes the viscosity of the melt to increases. As a result, there are cases where obtaining fine particles becomes difficult. There are also cases where a larger supply pump is required in order to maintain the pressure. On the other hand, when the nozzle diameter is excessively small, there are cases where the melt is likely to clog in the nozzle 17. Thus, the nozzle diameter is preferably 500 μm or less, more preferably 300 μm or less, and further more preferably 100 μm or less. Also, the nozzle diameter is preferably 5 μm or greater, more preferably 20 μm or greater, and further more preferably 50 μm or greater.

In the apparatus for producing particles 3, the melt in the high-pressure cell 51 is not directly jetted; rather, it is configured such that the melt is jetted from the nozzle 17 after passing through the high-pressure pipes (10q, 10e and 10f). Thereby, the compressive fluid mixed in the high-pressure cell 51 sufficiently diffuses in the pressure plastic material, which improves processability.

Next, in reference to FIG. 8, an apparatus for producing particles 4 as another embodiment is explained. Here, in the explanation of the apparatus for producing particles 4, identical reference signs may be used with their descriptions being omitted for units, mechanisms or devices which are in common with the apparatus for producing particles 3 in FIG. 7.

The apparatus for producing particles 4 includes a cell 11, a pump 12, a valve 13, a mixing device 15, a back-pressure valve 16 and a nozzle 17 connected by ultrahigh-pressure pipes (10a, 10b, 10c, 10e and 10f). In the apparatus for producing particles 4, a valve 33 is connected to the mixing device 15 by an ultrahigh-pressure pipe 10l. Also, a heater 38 is installed on the ultrahigh-pressure pipes 10l.

A cylinder 31 is a pressure tight case for storing and supplying a first compressive fluid. Here, the cylinder 31 may store a gas or a solid, provided that it becomes the compressive fluid by being heated by the heater 38 or being pressurized by a pump 32. In this case, in the mixing device 15, the gas or the solid stored in the cylinder 31 becomes any one of the states (1), (2) and (3) in the phase diagram of FIG. 4 due to heating or pressurization.

The cell 11 includes a temperature controller, and it has a function of heating the pressure plastic material filled in the cell 11 in advance. Also, the cell 11 is equipped with a stirring device, and thereby, the pressure plastic material is stirred for uniform heating.

The mixing device 15 has a function of mixing the pressure plastic material supplied from the cell 11 and the first compressive fluid supplied from the cylinder 31 by continuously contacting them. Specific examples of the mixing device 15 include a heretofore known T-shaped joint, a swirl mixer including a swirl flow and a central collision-type mixer in which two liquids collide in a mixing unit.

The back-pressure valve 16 has a function of adjusting a flow rate or a pressure of a melt by opening and closing a path between the mixing device 15 and the nozzle 17 (including a function of blocking).

When the apparatus for producing particles 4 is used, it is possible to produce particles without using a high-pressure cell 51, and thus a weight of the apparatus may be reduced. Also, in the apparatus for producing particles 4, the pressure plastic material is melted in advance by continuously contacting the pressure plastic material supplied from the cell 11 and the first compressive fluid supplied from the cylinder 31 in the mixing device 15. Thereby, it is possible to keep mixing the compressive fluid and the pressure plastic material at a constant ratio, and a homogeneous melt may be obtained.

Next, in reference to FIG. 9, an apparatus for producing particles 5 as yet another embodiment of the present invention is explained. Here, in the explanation of the apparatus for producing particles 5, identical reference signs may be used with their descriptions being omitted for units, mechanisms or devices which are in common with the apparatus for producing particles 3 in FIG. 7 or with the apparatus for producing particles 4 in FIG. 8.

In the apparatus for producing particles 5, a cylinder 41, a pump 42 and a back-pressure valve 46 are connected via ultrahigh-pressure pipes (10m and 10n), and the back-pressure valve 46 is connected to an ultrahigh-pressure pipes 10f via an ultrahigh-pressure pipes 10o. Also, a heater 48 is arranged, and it is possible to heat the ultrahigh-pressure pipes 10o.

The cylinder 41 is a pressure tight case for storing and supplying a second compressive fluid. It is preferable to use air, nitrogen, argon, helium or carbon dioxide as the second compressive fluid for safety reasons. Among these, in view of costs, it is preferable to use air, nitrogen and carbon dioxide. Here, a state of a substance stored in the cylinder 41 is a gas or a liquid, which may be converted to a compressive fluid in a middle of the path.

The pump 42 has a function of pumping the second compressive fluid stored in the cylinder 41 to a side of the nozzle 17. The back-pressure valve 46 has a function of adjusting a flow rate of the second compressive fluid by opening and closing a path between the pump 42 and the nozzle 17 (including a function of blocking). At this time, an accumulator not shown may be arranged between the pump 42 and the back-pressure valve 46.

The compressive fluid heated in the heater 48 is cooled at an exit of the nozzle 17 by the Joule-Thomson effect. Thus, it is preferable that the compressive fluid is sufficiently heated by the heater 48 and is in a state of a supercritical fluid (1) illustrated in the phase diagram in FIG. 4.

In the above-mentioned apparatus for producing particles 5, while the second compressive fluid is supplied to a raw materials melt including the first compressive fluid obtained in the mixing device 15, the melt is jetted from the nozzle 17. In this case, a viscosity of the melt of the pressure plastic material may be decreased by a pressure of the second compressive fluid, and accordingly, a process design having high processability becomes possible. Thereby, particles may be efficiently produced under conditions of a small amount of the releasing agent component added to the raw materials and a high molecular weight of the pressure plastic material.

Here, in the above apparatuses for producing particles (3, 4, 5), heretofore known fittings and so on are used as the mixing device 15. However, for example, when fluids having different viscosities such as melt resin and a compressive fluid are mixed in a conventional static mixer, it is difficult in many cases to mix the both fluids homogeneously. Accordingly, the static mixer of the present embodiment preferably includes a mixing element (element) in a tubular housing. This element does not include moving parts, and a plurality of baffle plates are arranged along an axial direction of the tube as a center. When such a static mixer is used, a fluid receives splitting, conversion and reversal actions by an element installed in the tube in the course of moving in a tubular housing, and thereby the fluid is mixed. Also, in a static mixer of another embodiment, it is possible to use a plurality of elements formed of a honeycomb plate composed of polygonal chambers superposed and aligned. In this type of a static mixer, a fluid sequentially moves outward from a central portion of the tube and to the central portion from the outside in the chambers inside the tube. However, when a high-viscosity fluid such as resin and a low-viscosity fluid such as compressive fluid are passed in these static mixers, the low-viscosity fluid does not receive a mixing action by the element and passes through a gap between the element in the tube and the tubular housing. As a result, the fluids may not be homogeneously mixed. As a workaround for this poor mixing, it is possible to increase complexity of the element structure or increase the length of the mixers. However, these workarounds are not effective in preventing the phenomenon of the low-viscosity fluid passing through, causing problems such as increased pressure loss during mixing, increased apparatus size and increased cleaning effort.

Here, the unit for supplying a second compressive fluid explained in FIG. 9 may be applied to the apparatus for producing particles of FIG. 7.

### [Method for Producing Toner]

Next, a method for producing a toner using the apparatus for producing particles (3, 4, 5) relating to the second embodiment is explained. The method for producing the toner of the present embodiment includes: a melting step, where the pressure plastic material and the releasing agent are contacted to the first compressive fluid at a temperature below the melting point of the releasing agent, and thereby the pressure plastic material is melted; and a granulating step, where a melt obtained in the melting step is jetted at a temperature below the melting point of the releasing agent for granulation.

### (Melting Step by Contacting Compressive Fluid)

Similarly to the first embodiment, the PGSS method is used in the present embodiment.

When the apparatus for producing particles 3 is used, in the melting step, first, the pressure plastic material, the releasing agent fine particles and other raw materials such as colorant are filled in the high-pressure cell 51. When the raw materials includes a plurality of components, components excluding the releasing agent fine particles is mixed in a mixer and melt-kneaded by a roller mill in advance before filling the raw materials.

Next, the high-pressure cell 51 is sealed, and the raw materials are stirred by a stirring device of the high-pressure cell 51. Then, by actuating the pump 32, first compressive fluid stored in the cylinder 31 is pressurized and by opening the valve 33, the first compressive fluid is supplied in the high-pressure cell 51. Here, in the present embodiment, a carbon dioxide cylinder is used as the cylinder 31.

A temperature in the high-pressure cell 51 is controlled by a temperature controller such that the supplied carbon dioxide becomes a compressive fluid. Here, an upper limit of the temperature in the high-pressure cell 51 may be appropriately selected as long as it is below the melting point of the releasing agent. It is preferably a thermal decomposition temperature of the pressure plastic material at atmospheric pressure or less, and it is more preferably a temperature a melting point of the pressure plastic material or less. Here, in the present embodiment, the thermal decomposition temperature denotes a starting temperature of a weight loss due to thermal decomposition of a sample in a measurement of a thermal analyzer (TGA: Thermo Gravimetry Analyzer).

When the temperature in the high-pressure cell 51 exceeds the thermal decomposition temperature, there are cases where degradation occurs due to oxidation of the pressure plastic material or a broken molecular chain, which decreases durability. There are also cases where an obtained toner has decreased color tone, transparency, fixing properties, heat-resistant storage stability and charging performance. Further, energy consumption increases in the heat treatment.

The pressure in the high-pressure cell 51 is adjusted to a certain pressure by controlling the pump 32 and the back-pressure valve 53. In the melting step in the present embodiment, a pressure applied to the raw materials such as pressure plastic material in the high-pressure cell 51 is not particularly restricted, and it may be appropriately selected according to purpose. Nonetheless, it is preferably 1 MPa or greater, more preferably 10 MPa to 200 MPa, and further more preferably 31 MPa to 100 MPa. When the pressure in the high-pressure cell 51 is less than 1 MPa, there are cases where a plasticization effect enough for granulation of the pressure plastic material cannot be obtained. On the other hand, there is no particular upper limit of the pressure in the high-pressure cell 51, but the apparatus becomes heavy as the pressure increases, resulting in an increased equipment cost.

In the high-pressure cell 51, the compressive fluid and the raw materials including the pressure plastic material contact, and thereby the pressure plastic material melts. In this case, the melt is stirred by the stirring device until the melt obtained by melting the pressure plastic material has a certain viscosity value. The viscosity of the melt is not particularly restricted as long as jetting is possible by the nozzle 17 with that viscosity, but jetting without clogging is possible even with a small nozzle diameter if the viscosity is small, which makes formation of fine particles easier. Thus, the melt has a viscosity of preferably 500 mPa·s or less, more preferably 300 mPa·s or less, and further more preferably 100 mPa·s or less. Also, it is preferably 20 mPa·s or less in order to obtain a toner for high image quality. When the melt has a viscosity exceeding 500 mPa·s, formation of particles becomes difficult, and there are cases where coarse particles, fibrous materials, foams or coalescence occur. Here, since the pressure plastic material is used in the present embodiment, the pressure of the compressive fluid promotes decrease in viscosity of the pressure plastic material. By homogeneously mixing of the pressure plastic material and the compressive fluid, the melt having a low viscosity may be obtained.

Meanwhile, when the apparatus for producing particles (4, 5) is used, in the melting step, first, raw materials such as pressure plastic material, releasing agent fine particles and colorant are filled in the cell 11. When the raw materials includes a plurality of components, components excluding the releasing agent fine particles are mixed in a mixer and melt-kneaded using a roller mill in advance before filling the raw materials.

Next, the cell 11 is sealed, and the raw materials are stirred by a stirring device of the cell 11 and heated. A temperature in the cell 11 is not particularly restricted as long as it is a temperature below the melting point of the releasing agent and at which the pressure plastic material plasticizes. Thereby, the pressure plastic material plasticizes.

Next, by actuating the pump 32, the first compressive fluid (in the present embodiment, carbon dioxide) stored in the cylinder 31 is pressurized, and the valve 33 is opened. Thereby, the first compressive fluid is supplied in the mixing device 15. Here, in the present embodiment, the cylinder 31 is a carbon dioxide cylinder. The supplied first compressive fluid is heated in the ultrahigh-pressure pipes 10l by the heater 38. A preset temperature of the heater 38 is not particularly restricted as long as the supplied carbon dioxide becomes a compressive fluid.

Next, the pump 12 is actuated, and the valve 13 is opened. Thereby, the pressure plastic material supplied from the cell 11 and the first compressive fluid supplied from the cylinder 31 continuously contacts in the mixing device 15 and homogeneously mixed. Thereby, the pressure plastic material melts. Similarly to the above, the melt obtained by melting the pressure plastic material has a viscosity of preferably 500 mPa·s or less, more preferably 300 mPa·s or less, and further more preferably 100 mPa·s or less. It is further more preferably 20 mPa·s or less in order to obtain a toner for high image quality.

In the apparatus for producing particles (4, 5), the pressure plastic material and the compressive fluid may be mixed with the viscosity difference between them reduced as much as possible by plasticizing the pressure plastic material in advance in the cell 11. Accordingly, it is possible to obtain a more homogeneous melt. Here, the pressure plastic material is plasticized in advance in the cell 11 by an application of heat, but it is possible to plasticize the pressure plastic material by application of pressure. It is also the pressure plastic material by application of both heat and pressure.

### (Granulating Step)

Next, the granulating step in which the melt obtained in the melting step is jetted to produce particles (toner in the present embodiment) is explained.

When the apparatus for producing particles (3, 4) is used, by opening the back-pressure valve 16, the melt (mixture) obtained by contacting the compressive fluid and the pressure plastic material in the high-pressure cell 51 or the mixing device 15 is jetted from the nozzle 17. At this time, in order to maintain a constant temperature and pressure in the high-pressure cell 51 or the cell 11, the back-pressure valve 53, the pump (12, 32) and the temperature controller and so on are controlled. Here, the pressures of the high-pressure cell 51 and the mixing device 15 are not particularly restricted.

The melt jetted from the nozzle 17 becomes particles, followed by solidification. Here, when the apparatus for producing particles 4 is used, the melt obtained by the pressure plastic material and the compressive fluid continuously contacting in the mixing device 15 is supplied to the nozzle 17, and thus continuous granulation of particles is possible.

When the apparatus for producing particles 5 is used, first, by actuating the pump 42 and by opening the back-pressure valve 46, second compressive fluid stored in the cylinder 41 is supplied to the nozzle 17. In the present embodiment, a nitrogen cylinder is used as the cylinder 41.

A pressure of the supplied second compressive fluid is not particularly restricted, and it may be appropriately selected according to purpose. Nonetheless, it is preferably 1 MPa or greater, more preferably 10 MPa to 200 MPa, and particularly preferably 31 MPa to 100 MPa. When the pressure applied to the second compressive fluid is less than 1 MPa, there are cases where a plasticizing effect sufficient for granulation of the pressure plastic material cannot be obtained. On the other hand, an upper limit of the pressure is not particularly restricted, but an equipment cost increases with the higher pressure.

The supplied second compressive fluid is heated in the ultrahigh-pressure pipes 10o by the heater 48. A preset temperature of the heater 48 is not particularly restricted as long as it is a temperature at which the supplied nitrogen becomes a compressive fluid and a temperature below the melting point of the releasing agent.

Next, by actuating the back-pressure valve 16, melt is supplied from the mixing device 15 to the nozzle 17. Thereby, with the second compressive fluid supplied to the melt, the melt may be jetted from the nozzle 17 to atmospheric pressure by a pressure difference.

In the present embodiment, the solid content concentration of the jetted melt decreases due to the supply of the second compressive fluid, which is preferable because the viscosity of the melt may be reduced further. As a result, not only the jetted melt is controlled to have a constant temperature but also the jet speed (exit linear velocity) increases, and a shear force on the melt increases due to the improved exit linear velocity. Also, by using nitrogen as the second compressive fluid, the nozzle 17 is less likely to clog because a temperature decrease due to the Joule-Thomson effect due to a pressure change near the nozzle 17 is relaxed. The melt jetted from the nozzle 17 becomes particles, followed by solidification. In this case, by a synergy of the reduced viscosity of the melt and reduced solid content concentration, uniform fine particles without coalescence may be produced over a long period of time. Also, a shape of the produced particles is uniformly stabilized. Here, when the apparatus for producing particles 5 is used, the pressure plastic material and the compressive fluid continuously contact in the mixing device 15, and the obtained melt is supplied to the nozzle 17. Accordingly, continuous granulation of the particles (toner) is possible.

Here, in the above-described embodiments, cases where the producing apparatus used for the method for producing particles (toner) is the apparatuses for producing particles (1, 2, 3, 4 and 5) illustrated in FIG. 5 to FIG. 9 are explained, which shall not be construed as limiting the scope of the present invention.

Also, in the above-described embodiments, cases where the melt including the pressure plastic material and the compressive fluid are jetted in the atmosphere are explained, which shall not be construed as limiting the scope of the present invention. Additionally, the melt may be jetted in an environment having a pressure greater than atmosphere and lower than the pressure in the nozzle 17. At this time, by controlling the jet speed (exit linear velocity), control of the particle diameter and the particle diameter distribution may be improved. Also, in these cases, since cooling of the melt jetted from the nozzle 17 by the Joule-Thomson effect may be relaxed, it is possible to suppress heating of the heater 48. As a result, effects such as energy savings and cost reduction may be achieved.

### (Methods for Producing Particles, and Particles)

A method for producing particles of a first embodiment of the present invention is a method for producing particles, including:

a mixing step, wherein a pressure plastic material and dispersed particles are continuously supplied and joined to continuously form a mixture of the pressure plastic material and the dispersed particles, and the mixture is continuously supplied to a next step;

a melting step, wherein a first compressive fluid and the mixture are brought into contact with each other to melt the mixture; and

a granulating step, wherein a melt obtained in the melting step is jetted for granulation.

wherein the particles include: a binder resin including the pressure plastic material; and a plurality of the dispersed particles, and the dispersed particles forming domain phases are dispersed in the pressure plastic material forming a continuous phase.

It further includes other steps according to necessity.

A method for producing particles of a second embodiment of the present invention is a method for producing particles, including:

a melting step, wherein a pressure plastic material and dispersed particles are brought into contact with a first compressive fluid at a temperature below a melting point of the dispersed particles to thereby melt the pressure plastic material; and

a granulating step, wherein a melt obtained in the melting step is jetted at a temperature below the melting point of the dispersed particles for granulation,

wherein the particles include: a binder resin including the pressure plastic material; and a plurality of the dispersed particles.

It further includes other steps according to necessity.

As the method for producing particles, items similar to the methods for producing a toner may be employed except that a raw material of the particles including a pressure plastic material and a dispersant is used in place of the raw material of the toner including: a binder resin including a pressure plastic material; and a releasing agent.

The dispersed particles are not particularly restricted and may be appropriately selected according to purpose so long as they can form domain phases without being miscible with the pressure plastic material forming a continuous phase. For example, those described as examples of the particulate releasing agent and colorant in the raw material of the toner may be used.

The combination of the pressure plastic material and the dispersed particles is not particularly restricted and may be appropriately selected according to purpose. Examples thereof include a polyester resin and paraffin.

The particles of the present invention are particles including a pressure plastic material. The particles include pores inside the particles, and the pores have an average maximum Feret diameter of 10 nm or greater but less than 500 nm.

The particles may be favorably produced by the method for producing particles of the first embodiment and the method for producing particles of the second embodiment.

By the methods for producing particles (toner) of the present embodiments, by using the compressive fluid, it is possible to produce particles (toner) without using an organic solvent. Accordingly, particles which substantially include no organic solvent may be obtained. Here, that the particles substantially including no organic solvent mentioned herein is that a content of an (organic) solvent in the particles measured by the following measurement method is below a detection limit.

The measurement method of a residual solvent in the particles is explained below. First, 1 part by mass of particles to be measured and 2 parts by mass of 2-propanol were added and subjected to ultrasonic dispersion for 30 minutes. After it is stored in a refrigerator (5° C.) for 1 day or more, the solvent in the particles is extracted. The supernatant solution is analyzed using a gas chromatography (GC-14A, SHIMADZU), and the solvent in the particles and a residual monomer is quantified. Thereby, a residual solvent concentration is measured. In the present embodiments, the measurement conditions during analysis are as follows.

Apparatus: SHIMADZU GC-14A;

Column: CBP20-M 50-0.25;

Detector: FID;

Injection Amount: 1 μL to 5 μL;

Carrier Gas: He 2.5 kg/cm^{2;}

Hydrogen Flow Rate: 0.6 kg/cm^{2;}

Air Flow Rate: 0.5 kg/cm^{2;}

Chart Speed: 5 mm/min;

Sensitivity: Range 101×Atten 20;

Column Temperature: 40° C.;

Injection Temp: 150° C.

Also, in the methods for producing particles of the present embodiments, it is possible to produce particles having pores inside the particles. At this time, it is preferable that the pores of the produced particles have an average maximum Feret diameter of preferably 10 nm or greater but less than 500 nm, more preferably 10 nm or greater but less than 300 nm. The maximum Feret diameter refers to a diameter with which parallel lines which sandwich an object have the largest interval.

When they are used as a toner, the particles having pores provides benefits such as: reduced power consumption in fixing the toner on a recording material; longer life of the toner due to external additives such as hydrophobic silica being less likely to be embedded; and reduction of energy for stirring due to reduction of stirring stresses caused when it is mixed with a carrier and charged.

Also, in a case of particles of biocompatible resin such as polylactic acid, the particles may be used as scaffolds for controlling sustained release of drugs or regenerating biological tissue.

Here, average values of maximum Feret diameters of the releasing-agent particles and the pores are obtained as follows. A cross-section of the particles is observed by, for example, an electron microscope, and a cross-sectional photograph is taken. The cross-sectional photograph is processed and binarized by an image processing software, and releasing-agent portions or pore portions are identified. Among the maximum Feret diameters of the identified releasing-agent particles or the pores, 30 of them are selected in order of larger diameter, and an average thereof is regarded as the average of the maximum Feret diameter of the releasing agent or the pores.

### <Toner>

When a toner is produced by the present embodiments, properties such as shape and size of the obtained toner are not particularly restricted, and they may be appropriately selected according to purpose. Nonetheless, a preferable toner has the following image density, average circularity, mass-average particle diameter and ratio of the mass-average particle diameter to the number-average particle diameter (mass-average particle diameter/number-average particle diameter).

Here, the image density of the toner is a concentration value measured using a spectrometer (938 Spectrodensitometer, manufactured by X-Rite Inc.), and it is preferably 1.90 or greater, more preferably 2.00 or greater, and further more preferably 2.10 or greater. When the toner has an image density of less than 1.90, the low image density may result in failure to obtain a high-quality image. Here, the image density of the toner may be measured as follows, for example. First, using IMAGIO NEO 450 (manufactured by Ricoh Company, Ltd.), a solid image having an adhered amount of a developer of 1.00±0.05 mg/cm² is formed on copy paper (TYPE6000<70W>, manufactured by Ricoh Company, Ltd.) under a condition that a fixing roller has a surface temperature of 160±2° C. Then, the obtained solid image was subjected to a measurement of image density at arbitrary six (6) locations thereof using the above spectrometer, and an average thereof is calculated as the image density.

The average circularity of the toner is defined as a value obtained by dividing a perimeter of a circle having an area equivalent to a projection area of a toner shape toner by a perimeter of a real particle, and it is preferably 0.900 to 0.980, more preferably 0.950 to 0.975. Also, it is preferable that toner particles having an average circularity of less than 0.94 is 15% by mass or less. When the average circularity is less than 0.900, there are cases where satisfactory transfer property or a high-quality image without dust cannot be obtained. Also, when the average circularity exceeds 0.980, there are cases for an image forming system which employs blade cleaning that cleaning failure occurs on a photoconductor and a transfer belt, causing smear on an image. Specifically, for example, in forming an image having a high image area ratio such as photographic image, there are cases where a toner forming an image which has not been transferred yet due to paper-feeding problem and so on becomes a transfer residual toner and accumulates on a photoconductor, causing a background smear of the image. Also, there are cases where it contaminates a charge roller which contacts and charges a photoconductor, failing to demonstrate the original charging performance.

Here, the average circularity mentioned herein may be measured using a flow particle image analyzer, e.g., a flow particle image analyzer FPIA-2000, manufactured by Sysmex Corporation. In this case, first, water adjusted to have a number of particles having a size in a measurement range (e.g. equivalent circle diameter of 0.60 μm or greater but less than 159.21 μm) of 20 or less per 10-3 cm³ of the water is prepared by filtering it to remove fine dusts. Next, in 10 mL of this water including particles, a few drops of a non-ionic surfactant (preferably CONTAMINON N, manufactured by Wako Pure Chemical Industries, Ltd) is added, and further, 5 mg of a measurement sample is added. This is subjected to a dispersion treatment using an ultrasonic disperser (UH-50, manufactured by SMT Co., Ltd.) at 20 kHz and 50 W/10 cm³ for 1 minute and a further dispersion treatment for 5 minutes in total. Using a sample dispersion liquid having a particles concentration of the measurement sample of 4,000/10⁻³ cm³ to 8,000/10⁻³ cm³ (for particles in the measured equivalent circle diameter range) by the dispersion treatment, a particle size distribution of particles having an equivalent circle diameter of 0.60 μm or greater but less than 159.21 μm is measured.

The average circularity is measured by passing the sample dispersion liquid through a flow path (spreading along a flow direction) of a flat and transparent flow cell (having a thickness of about 200 μm). Here, in order to form an optical path passing across a thickness of the flow cell, a strobe and a CCD camera are mounted on the flow cell to be positioned opposite to each other. While the sample dispersion liquid is flowing, the strobe light is irradiated at an interval of 1/30 seconds in order to obtain images of particles flowing in the flow cell. As a result, photographs of each particle are taken as a two-dimensional image being parallel with the flow cell in a certain range. From an area of each particle in the two-dimensional images, a diameter of a circle having an identical area is calculated as the equivalent circle diameter. In that way, the equivalent circle diameters of 1,200 or particles are measured in about 1 minute, and ratios of particles of a frequency based on the equivalent circle diameter distribution and having a specific equivalent circle diameter (% by number) are calculated. The results (frequency percent and cumulative percent) may be obtained by dividing the range of 0.06 μm to 400 μm into 226 channels (1 octave is divided into 30 channels). In an actual measurement, a measurement of particles is carried out in a range of the equivalent circle diameter of 0.60 μm or greater but less than 159.21 μm.

The mass-average particle diameter of the toner is not particularly restricted, and it may be appropriately selected according to purpose. Nonetheless, it is preferably 3 μm to 10 μm, more preferably 3 μm to 8 μm. When the mass-average particle diameter is less than 3 μm, the toner is fused on a surface of the carrier during long-term stirring of the two-component developer in a developing device, which may decrease charging performance of the carrier. Also, as for the one-component developer, due to toner filming on a developing roller or thinning of the toner, there are cases where the toner fused on members such as blade easily occurs. Also, when the mass-average particle diameter exceeds 10 μm, there are cases where it is technically difficult to obtain a high-quality image with high resolution. Also, when the toner in the developer is balanced, there are cases where variation of the particle diameter of the toner increases.

The ratio of the mass-average particle diameter to the number-average particle diameter (mass-average particle diameter/number-average particle diameter) in the toner is preferably 1.00 to 1.25, more preferably 1.00 to 1.10. When the ratio of the mass-average particle diameter to the number-average particle diameter (mass-average particle diameter/number-average particle diameter) exceeds 1.25, the toner is fused on a surface of the carrier during long-term stirring of the two-component developer in a developing device, which may decrease charging performance of the carrier. Also, when the ratio of the mass-average particle diameter to the number-average particle diameter (mass-average particle diameter/number-average particle diameter) exceeds 1.25, in the one-component developer, due to toner filming on a developing roller or thinning of the toner, there are cases where the toner fused on members such as blade easily occurs. Also, there are cases where it is technically difficult to obtain a high-quality image with high resolution. Also, when the toner in the developer is balanced, there are cases where variation of the particle diameter of the toner increases.

The mass-average particle diameter and the ratio of the mass-average particle diameter to the number-average particle diameter (mass-average particle diameter/number-average particle diameter) may be measured, for example, using a particle size measuring instrument “COULTER COUNTER TAII” manufactured by Beckman Coulter, Inc.

A content of the releasing agent in the toner is determined from endothermic properties obtained by differential scanning calorimetry (DSC) measurement. In the present embodiments, the following measurement conditions are used for the analysis.

Apparatus: SHIMADZU DSC-60A;

Heating Rate: 1° C./min, 10° C./min, or 20° C./min;

Measurement Starting Temperature: 20° C.;

Measurement Ending Temperature: 180° C.

Specifically, about 5 mg of a sample is accurately weighed and placed in a silver pan for measurement. An empty silver pan is used as a reference.

With the toner as the sample, when a maximum endothermic peak (endothermic peak derived from the binder resin) does not overlap with an endothermic peak of the releasing agent, the obtained maximum endothermic peak is directly treated as an endothermic peak derived from the binder resin. On the other hand, with the toner as the sample, when an endothermic peak of the releasing agent overlaps with a maximum endothermic peak of the binder resin, it is necessary to subtract the endothermic quantity derived from the releasing agent from the obtained maximum endothermic peak.

For example, the endothermic quantity derived from the releasing agent is subtracted from the obtained maximum endothermic peak to obtain the endothermic peak derived from the binder resin by the following method.

First, a DSC measurement of the releasing agent alone is carried out separately, and its endothermic properties are obtained. Next, a content of the releasing agent in the toner is obtained. A measurement of the releasing agent content in the toner is not particularly restricted, but examples thereof include a peak separation in a DSC measurement and heretofore known structural analyses. Thereafter, an endothermic quantity attributable to the releasing agent is calculated from the releasing agent content in the toner, and this quantity is subtracted from the maximum endothermic peak. When the releasing agent is easily miscible with the resin component, it is necessary to calculate the endothermic quantity attributable to the releasing agent with the content of the releasing agent multiplied by a miscibility rate and to subtract this quantity. The miscibility rate is calculated by dividing an endothermic quantity of a mixture of a melt mixture of the resin component and the releasing agent at a predetermined ratio by a theoretical endothermic quantity calculated from an endothermic quantity of the melt mixture and an endothermic quantity of the releasing agent alone which are obtained in advance.

Also, in the measurement, it is necessary to exclude the mass of the components other than the binder resin from the mass of the sample in order to obtain an endothermic quantity per 1 g of the binder resin.

A content of the components other than the resin component may be measured by heretofore known analytical means. When an analysis is difficult, the following method may be used. That is, first, an amount of an incineration ash residue of the toner is obtained. Then, an amount obtained by adding it with an amount of components other than the binder resin to be incinerated such as releasing agent is regarded as the content of the components other than the binder resin, and it is subtracted from the mass of the toner. Thereby, the content of the components other than the resin component may be calculated.

The amount of the incineration ash residue in the toner is obtained according to the following procedure. About 2 g of the toner is placed in a pre-weighed 30-mL magnetic crucible. The crucible is placed in an electric furnace and heated at about 900° C. for about 3 hours. It is then allowed to cool in the electric furnace and allowed to cool in a desiccator at a normal temperature over 1 hour. The crucible including the incineration ash residue is weighed, from which the mass of the crucible is subtracted. Thereby, the amount of the incineration ash residue is calculated.

Here, the maximum endothermic peak is a peak with the maximum endothermic quantity when there is more than one peak. Also, a temperature width at a half of the height (½ h) with respect to the peak height (h) of the maximum endothermic peak, which is referred to as a half width.

### (Developer)

Next, a developer including the toner of the present embodiments is explained. The developer relating to the present embodiments is not particularly restricted as long as it includes the above-described toner. It may be a one-component developer or a two-component including the toner and a magnetic carrier.

Also, the above-described toner may be a colored toner of yellow, cyan, magenta or black or a colorless and transparent clear toner.

### <Magnetic Carrier>

The above-mentioned magnetic carrier of the two-component developer is not particularly restricted as long as it includes a magnetic material, and it may be appropriately selected according to purpose. Nonetheless, examples thereof include hematite, iron powder, magnetite and ferrite.

A content of the magnetic carrier with respect to 100 parts by mass of a toner is preferably 5% by mass to 50% by mass, more preferably 10% by mass to 30% by mass.

### (Image Forming Apparatus)

An image forming apparatus of the present invention includes: a photoconductor; a latent electrostatic image forming unit, which forms a latent electrostatic image on the photoconductor; a developing unit, which includes a developer including a toner and forms a visible image by developing the latent electrostatic image using the developer; a transferring unit, which transfers the visible image to a recording medium; and a fixing unit, which fixes the visible image transferred on the recording medium, and it further includes other units according to necessity.

The toner is the toner of the present invention.

Next, in reference to FIG. 10, an image forming apparatus relating to the present embodiments is explained. FIG. 10 is a schematic diagram illustrating an image forming apparatus relating to the present embodiments.

An image forming apparatus 200 develops a latent electrostatic image using the toner produced by the method for producing particles described above into a visible image, and an image is formed by transferring and fixing this visible image to paper as an example of a recording medium. Here, in the present embodiments, an example with the image forming apparatus 200 as an electrophotographic printer is explained. However, the present invention is not restricted to this example, and it may be a copying machine, a facsimile and so on.

As illustrated in FIG. 10, the image forming apparatus 200 is equipped with: a paper feeding element 210; a conveying element 220; an image forming element 230; a transferring element 240; and a fixing element 250.

The paper feeding element 210 is equipped with: a paper feeding cassette 211 loaded with paper to be fed; and a feeding roller 212 for feeding one by one the paper loaded on the paper feeding cassette 211.

The conveying element 220 is equipped with: rollers 221 which convey the paper fed by the feeding roller 212 toward the transferring element 240; a pair of timing rollers 222 which stands by while pinching a tip of the paper conveyed by the roller 221 and sends the paper at a predetermined timing toward the transferring element 240; and paper ejecting rollers 223 which discharge the paper on which a toner is fixed by the fixing element 250 in an ejection tray 224.

The image forming element 230 is equipped with, at a predetermined interval and in order from left to right in FIG. 10: an image forming unit Y which forms an image using a developer including a yellow toner (toner Y); an image forming unit C which forms an image using a developer including a cyan toner (toner C); an image forming unit M which forms an image using a developer including a magenta toner (toner M); an image forming unit K which forms an image using a developer including a black toner (toner K); and an exposure device 233. Here, the toners (Y, C, M and K) are the toners obtained respectively by the above-described producing method.

In FIG. 10, the four (4) image forming units have a substantially identical configuration except that the developers used therein are different. The respective image forming units are, in FIG. 10, disposed in a manner rotatable in a clockwise direction, and they are equipped with: photoconductor drums (231Y, 231C, 231M, 231K) which bear a latent electrostatic image and a toner image; chargers (232Y, 232C, 232M, 232K) which uniformly charges a surface of the photoconductor drums (231Y, 231C, 231M, 231K); toner cartridges (237Y, 237C, 237M, 237K) which supply the toners of respective colors (Y, C, M, K); developing devices (234Y, 234C, 234M, 234K) which develops the latent electrostatic image formed on the surface of the photoconductor drums (231Y, 231C, 231M, 231K) by the exposure device 233 using the toner supplied from toner cartridges (237Y, 237C, 237M, 237K) into toner images; neutralization devices (235Y, 235C, 235M, 235K) which neutralize the surface of the photoconductor drum (231Y, 231C, 231M, 231K) after primary transfer of the toner image to the transfer medium; and cleaners (236Y, 236C, 236M, 236K) which removes transfer residual toners remaining on the surface of the photoconductor drums (231Y, 231C, 231M, 231K) neutralized by the neutralization devices (235Y, 235C, 235M, 235K).

The exposure device 233 is a device which reflects a laser beam L irradiated from a light source 233a and reflects it with polygon mirrors (233bY, 233bC, 233bM, 233bK) rotationally driven by motors to irradiate the photoconductor drums (231Y, 231C, 231M, 231K) based on image information. Thereby, latent electrostatic images based on the image information are formed on the photoconductor drums 231.

The transferring element 240 is equipped with: a driving roller 241 and a driven roller 242; an intermediate transfer belt 243 as a transfer medium, which is stretched over these rollers and is driven by the driving roller 241 to rotate in a counterclockwise direction in FIG. 10; primary transfer rollers (244Y, 244C, 244M, 244K) provided facing the photoconductor drums 231 across the intermediate transfer belt 243; and a secondary transfer roller 246 provided facing a secondary counter roller 245 across the intermediate transfer belt 243 at a transfer location of the toner image to the paper.

In the transferring element 240, a primary transfer bias is applied on the primary transfer rollers 244, and thereby the toner images formed on a surface of the respective photoconductor drums 231 are transferred on the intermediate transfer belt 243 (primary transfer). Also, a secondary transfer bias is applied on the secondary transfer roller 246, and thereby the toner image on the intermediate transfer belt 243 is transferred on paper which is sandwiched by the secondary transfer roller 246 and the secondary counter roller 245 and being conveyed (secondary transfer).

The fixing element 250 includes a heater provided therein, and it is equipped with: a heat roller 251 which heats the paper to a temperature higher than a minimum fixing temperature of the toner; and a pressure roller 252 which forms a contact surface (nip portion) by pressing rotatably the heat roller 251. Here, in the present embodiments, the minimum fixing temperature means a lower-limit temperature at which the toner fixes.

In the image forming apparatus in the present embodiments, an image is formed using the toner produced by the producing methods of the present embodiments, having a sharp particle size distribution and favorable toner properties such as charging property, environmental performance and stability over time, and thus a high-quality image may be formed.

### EXAMPLES

### Examples

Next, the present invention is explained in more detail in reference to examples and Comparative examples, but the examples shall not be construed as limiting the scope of the present invention. Here, in the following description, “parts” and “%” denote “parts by mass” and “% by mass”, respectively, unless otherwise specified.

### —Synthesis of Polyester Resin 1 (Pressure Plastic Material)—

A reactor equipped with a cooling tube, a stirrer and a nitrogen inlet tube was charged with: 229 parts of ethylene oxide 2-mole adducts of bisphenol A; 529 parts of propylene oxide 3-mole adducts of bisphenol A; 208 parts of terephthalic acid; 46 parts of adipic acid; and 2 parts of dibutyltin oxide, and it was allowed to react at 230° C. under a normal pressure for 8 hours. Also, it was continued to react under a reduced pressure of 10 mmHg to 15 mmHg for 5 hours. Thereafter, the reactor was charged with 44 parts of anhydrous trimellitic acid, and it was allowed to react at 180° C. under a normal pressure for 2 hours. Thereby, [Polyester Resin 1] was obtained. Obtained [Polyester Resin 1] had a weight-average molecular weight of 6,700, a Tg of 43° C., an acid value of 25 mgKOH/g, and a slope of a change in glass transition temperature with respect to a pressure of −10° C./MPa.

Here, a high-pressure calorimeter apparatus C-80 (manufactured by SETARAM) for measuring the glass transition temperature and the slope. For the measurements, first, a sample was set in a high-pressure measuring cell, and the cell was purged with carbon dioxide and pressurized to a predetermined pressure. Then, it was heated to 200° C. at a heating rate of 0.5° C./min, and the glass transition temperature was measured.

### —Polylactic Resin—

[Polylactic Resin] obtained by ring-opening polymerization of a mixture of L-lactide and D-lactide (90/10, molar ratio) was used. [Polylactic Resin] had a Mw of about 20,000 and a slope of a change in glass transition temperature with respect to a pressure of −25° C./MPa.

### —Synthesis of Polyester Resin 2 (Pressure Plastic Material)—

A reactor equipped with a cooling tube, a stirrer and a nitrogen inlet tube was charged with: 283 parts of sebacic acid; 215 parts of 1,6-hexanediol; and 1 part of titanium dihydroxybis(triethanolaminate) as a polycondensation catalyst, and it was allowed to react at 180° C. under a stream of nitrogen for 8 hours while distilling generated water. Next, while heating gradually to 220° C., it was continued to react for 4 hours under a stream of nitrogen with generated water and 1,6-hexanediol distilled. Further, the reaction was continued under a reduced pressure of 5 mmHg to 20 mmHg until a Mw reached about 17,000, and [Polyester Resin 2](crystalline polyester resin) having a melting point of 63° C. was obtained. [Polyester Resin 2] had a slope of a change in glass transition temperature with respect to a pressure of −5° C./MPa.

### —Synthesis of Polyurethane Resin 1 (Pressure Plastic Material)—

A reactor equipped with a cooling tube, a stirrer and a nitrogen inlet tube was charged with: 283 parts of sebacic acid; 215 parts of 1,6-hexanediol; and 1 part of titanium dihydroxybis(triethanolaminate) as a polycondensation catalyst, and it was allowed to react under a stream of nitrogen at 180° C. for 8 hours while distilling generated water. Next, while it was gradually heated to 220° C., it was continued to react for 4 hours under a stream of nitrogen with generated water and 1,6-hexanediol distilled. Further, the reaction was continued under a reduced pressure of 5 mmHg to 20 mmHg until a Mw reached about 6,000. Then, 249 parts of an obtained crystalline resin was moved to a reactor equipped with a cooling tube, a stirrer and a nitrogen inlet tube, 250 parts of ethyl acetate and 9 parts of hexamethylene diisocyanate (HDI) were added, and it was allowed to react under a stream of nitrogen at 80° C. for 5 hours. Thereafter, ethyl acetate was distilled under a reduced pressure, and [Polyurethane Resin 1](crystalline polyurethane resin) having a Mw of about 20,000, and a melting point of 65° C. was obtained. [Polyurethane Resin 1] had a slope of a change in glass transition temperature with respect to a pressure of −6° C./MPa.

Parameters such as glass transition temperature Tg, melting point Ta, softening temperature Tb and Tb/Ta of the various resins thus obtained are shown in Table 1.

TABLE 1

| | | Glass | | | |
|---|---|---|---|---|---|
| | | transition | Melting | Softening | |
| | | temperature | point | temperature | Tb/ |
| Resin | | Tg (° C.) | Ta (° C.) | Tb (° C.) | Ta |
| Non- | Polyester | 43 | — | — | — |
| crystalline | Resin 1 | | | | |
| resin | | | | | |
| Crystalline | Polyester | — | 63 | 63 | 1.00 |
| resin | Resin 2 | | | | |
| Crystalline | Polyurethane | — | 65 | 75 | 1.15 |
| resin | Resin 1 | | | | |
| Non- | Polylactic | 50 | — | — | — |
| crystalline | Acid | | | | |
| resin | | | | | |

### Example 1

In Example 1, a toner was produced using an apparatus for producing particles 2 in FIG. 6 as one example of the first embodiment. Here, a carbon dioxide cylinder was used as a cylinder 31, and a nitrogen cylinder was used as a cylinder 41.

Also, in Example 1, the following was used as raw materials.

| | |
|---|---|
| Polyester Resin 1 | 95 parts |
| Colorant [Copper Phthalocyanine Blue (manufactured by | 5 parts |
| Dainichiseika Color & Chemicals Mfg. Co., Ltd., C.I. | |
| Pigment Blue 15:3)] | |
| Paraffin wax (melting point 79° C.) | 5 parts |

The raw materials excluding the paraffin wax were mixed in a mixer and then subjected to melt-kneading using a two-roll mill, and the kneaded product was rolled for cooling. This kneaded product was placed in a cell 11 of the apparatus for producing particles 2 of FIG. 6 and heated to 150° C.

Also, the paraffin wax was placed in a cell 21 of the apparatus for producing particles 2 and heated to 150° C.

Next, by actuating a pump 12 and opening a valve 13, the kneaded product was supplied to a mixing device 14. Also, by actuating a pump 22 and opening a valve 23 to supply the paraffin wax to the mixing device 14, the mixture and the paraffin wax were mixed in the mixing device 14. Thereby, a raw-material mixture was obtained.

Next, by actuating a pump 32 and opening a valve 33, carbon dioxide was introduced as a first compressive fluid such that it had a temperature and a pressure of 150° C. and 65 MPa, respectively. Also, the raw-material mixture obtained in the mixing device 14 was supplied to a mixing device 15 so that the raw-material mixture and the first compressive fluid were brought into continuous contact and mixed in the mixing device 15, and a melt was obtained.

The obtained melt had a viscosity of 4 mPa·s. Here, an oscillation viscometer (XL7, manufactured by Hydramotion) was used for measuring the viscosity of the melt, and the measurement was carried out under the conditions described below. A sample and a compressive fluid (carbon dioxide) were introduced in a high-pressure cell, and a viscosity measurement was carried out under the conditions of 150° C. and 65 MPa.

Next, a back-pressure valve 46 was opened, and using a pump 42 and a heater 48, supercritical nitrogen was jetted as a second compressive fluid from a nozzle 17 to maintain its pressure and temperature of 65 MPa and 150° C., respectively. As the nozzle 17, a nozzle having a hole diameter of 100 μm was used. By opening a back-pressure valve 16 at this condition, the melt obtained by contacting the raw-material mixture and the first compressive fluid was continuously jetted from the nozzle 17 with the second compressive fluid supplied to the melt. Here, a porous filter was arranged between the back-pressure valve 16 and the nozzle 17.

Here, the melt which passes through an ultrahigh-pressure pipe 10f had a constant temperature and a constant pressure of 100° C. and 65 MPa, respectively, by adjusting the pump 12, the pump 22, the pump 32, the back-pressure valve 16 and the back-pressure valve 46. The jetted melt was atomized followed by solidification. The solidified toner was regarded as [Toner 1].

Particles of [Toner 1] thus obtained had a volume-average particle diameter (Dv) of 5.3 μm, a number-average particle diameter (Dn) of 4.7 μm and a Dv/Dn of 1.13. Here, the volume-average particle diameter and the ratio of the volume-average particle diameter to the number-average particle diameter (volume-average particle diameter/number-average particle diameter) were measured using a particle size measuring instrument “COULTER COUNTER TAII” manufactured by Beckman Coulter, Inc.

Also, the particles of obtained [Toner 1] had a residual solvent concentration below a detection limit. Here, the residual solvent concentration was measured using a gas chromatography (GC-14A) manufactured by Shimadzu Corporation.

The particles of obtained [Toner 1] had a releasing agent content of 4.8% by mass. Here, the releasing agent content was obtained from endothermic properties measured using an automatic differential scanning calorimeter (DSC-60A) manufactured by Shimadzu Corporation.

Table 2-1 to Table 2-3 show various producing conditions in Example 1 as well as other Examples and Comparative Examples described hereinafter. Note in Table 2-3 that “-” in the columns “Maximum Feret diameter of pores” and “Maximum Feret diameter of releasing agent particles” means “not measured”.

TABLE 2-1

| | | Process | | | Nozzle |
|---|---|---|---|---|---|
| | | temper- | Process | Viscosity | hole |
| | | ature | pressure | of melt | diameter |
| | Toner No. | (° C.) | (MPa) | (mPa · s) | (μm) |
| Example 1 | Toner 1 | 150 | 65 | 4 | 100 |
| Example 2 | Toner 2 | 150 | 50 | 3 | 100 |
| Example 3 | Toner 3 | 135 | 40 | 18 | 100 |
| Example 4 | Toner 4 | 120 | 10 | 75 | 200 |
| Example 5 | Toner 5 | 100 | 7 | 250 | 300 |
| Example 6 | Toner 6 | 80 | 5 | 450 | 400 |
| Example 7 | Toner 7 | 150 | 50 | 2 | 100 |
| Example 8 | Toner 8 | 120 | 15 | 45 | 200 |
| Example 9 | Toner 9 | 70 | 65 | 20 | 100 |
| Example 10 | Toner 10 | 70 | 10 | 470 | 400 |
| Example 11 | Toner 11 | 70 | 13 | 320 | 300 |
| Example 12 | Toner 12 | 70 | 16 | 170 | 200 |
| Example 13 | Toner 13 | 70 | 20 | 84 | 200 |
| Example 14 | Toner 14 | 70 | 65 | 2 | 100 |
| Example 15 | Toner 15 | 70 | 50 | 10 | 100 |
| Example 16 | Toner 16 | 70 | 65 | 3 | 100 |
| Example 17 | Particles 17 | 170 | 65 | 45 | 200 |
| Comparative | Comparative | — | — | — | — |
| Example 1 | Toner 1 | | | | |

TABLE 2-2

| | | | | Plurality of |
|---|---|---|---|---|
| | Volume- | Number- | | particles of |
| | average particle | average particle | | releasing agent |
| | diameter (μm) | diameter (μm) | Dv/Dn | encapsulated |
| Example 1 | 5.3 | 4.7 | 1.13 | B |
| Example 2 | 5.2 | 4.7 | 1.11 | B |
| Example 3 | 8.6 | 6.4 | 1.34 | B |
| Example 4 | 16.3 | 6.3 | 2.59 | B |
| Example 5 | 35.8 | 8.1 | 4.42 | B |
| Example 6 | 63.5 | 8.8 | 7.22 | B |
| Example 7 | 5.5 | 4.8 | 1.15 | B |
| Example 8 | 12.8 | 6.1 | 2.10 | B |
| Example 9 | 9.1 | 7.0 | 1.30 | B |
| Example 10 | 76.2 | 9.5 | 8.02 | B |
| Example 11 | 40.1 | 8.3 | 4.83 | B |
| Example 12 | 26.7 | 7.0 | 3.81 | B |
| Example 13 | 19.2 | 6.3 | 3.05 | B |
| Example 14 | 5.0 | 4.5 | 1.11 | B |
| Example 15 | 5.7 | 5.0 | 1.14 | B |
| Example 16 | 5.2 | 4.6 | 1.13 | B |
| Example 17 | 12.5 | 6.0 | 2.08 | B |
| Comparative | 5.4 | 4.8 | 1.13 | D |
| Example 1 | | | | |

TABLE 2-3

| | | Maximum | | |
|---|---|---|---|---|
| | Maximum | Feret | Releasing | |
| | Feret | diameter of | agent | |
| | diameter of | releasing agent | content | Residual |
| | pores (nm) | particles (nm) | (% by mass) | solvent |
| Example 1 | 250 | 700 | 4.8 | N/D* |
| Example 2 | 240 | 750 | 4.7 | N/D* |
| Example 3 | 480 | 800 | 4.5 | N/D* |
| Example 4 | — | — | — | N/D* |
| Example 5 | — | — | — | N/D* |
| Example 6 | — | — | — | N/D* |
| Example 7 | 240 | 680 | 4.8 | N/D* |
| Example 8 | — | — | — | N/D* |
| Example 9 | 500 | 850 | 4.6 | N/D* |
| Example 10 | — | — | — | N/D* |
| Example 11 | — | — | — | N/D* |
| Example 12 | — | — | — | N/D* |
| Example 13 | — | — | — | N/D* |
| Example 14 | 210 | 600 | 4.8 | N/D* |
| Example 15 | 280 | 750 | 4.9 | N/D* |
| Example 16 | 250 | 700 | 4.7 | N/D* |
| Example 17 | 500 | — | — | N/D* |
| Comparative | No pores | — | 5.2 | 50 ppm |
| Example 1 | | | | |

*N/D means “below a detection limit”.

### Examples 2 to 6

[Toners 2 to 6] were respectively obtained in the same manner as Example 1 except that [Polyester Resin 1] used in Example 1 was changed to [Polyester Resin 2] and that the process temperature, the process pressure and the nozzle diameter were changed to the values shown for Examples 2 to 6 in Table 2-1 to Table 2-3.

### Examples 7 and 8

[Toners 7 and 8] were respectively obtained in the same manner as Example 1 except that [Polyester Resin 1] used in Example 1 was changed to [Polyurethane Resin 1] and that the process temperature, the process pressure and the nozzle diameter were changed to the values shown for Example 7 and Example 8 in Table 2-1 to Table 2-3.

In Examples 9 to 16, toners were produced using a releasing agent which was atomized in advance.

### —Production of Paraffin Wax Fine Particles (Releasing Agent Particles)—

Paraffin wax having a melting point of 79° C. was placed in a high-pressure cell. Carbon dioxide was introduced in the high-pressure cell as a supercritical fluid adjusted to have a temperature of 40° C. and a pressure of 40 MPa, followed by stirring for 1 hour. An obtained melt had a viscosity below a detection limit (1 mPa·s or less). Here, an oscillation viscometer (XL7, manufactured by Hydramotion) was used for the measurement of the viscosity of the melt. A sample and a compressive fluid (carbon dioxide) were placed in a high-pressure cell, and a viscosity measurement was carried out under conditions of 40° C. and 40 MPa. Next, while maintaining the conditions of 40° C. and 40 MPa using a pump and a heater, the melt of the releasing agent was introduced to a granular material forming unit of a discharge device. The melt was introduced to a reservoir section of the discharge device, and a sine wave having an AC frequency of 320 kHz was applied to a vibration unit composed of laminated PZT. Thereby, the discharge device was excited to form a granular material, which was discharged under an atmospheric pressure, and wax fine particles were obtained. As through-holes for the discharge, a SUS (stainless steel) having a thickness of 50 μm with 100 holes having a diameter of 8.0 μm drilled in a houndstooth pattern was used. Here, in the high-pressure cell, a constant temperature and a constant pressure of 40° C. and 40 MPa, respectively, were maintained. Also, it was controlled such that a difference between a pressure in the reservoir section and a pressure in the granular material forming unit was 80±50 kPa. The obtained wax fine particles had a volume-average particle diameter (Dv) of 0.33 μm, a number-average particle diameter (Dn) of 0.32 μm and a Dv/Dn of 1.03. Here, in the present example, the volume-average particle diameter (Dv) and a ratio of volume-average particle diameter to number-average particle diameter were measured using a particle size measuring instrument (COULTER COUNTER TAII) manufactured by Beckman Coulter, Inc.

### Example 9

In Example 9, a toner was produced using an apparatus for producing particles 3 in FIG. 7 as one example of a second embodiment with a means for supplying a second compressive fluid in FIG. 9 applied thereto. In Example 9, a carbon dioxide cylinder was used as a cylinder 31, and a nitrogen gas cylinder was used as a cylinder 41. Also, in Example 9, the following was used as raw materials.

| | |
|---|---|
| Polyester Resin 1 | 95 parts |
| Colorant [Copper Phthalocyanine Blue (manufactured by | 5 parts |
| Dainichiseika Color & Chemicals Mfg. Co., Ltd., C.I. | |
| Pigment Blue 15:3)] | |
| Paraffin wax fine particles (melting point 79° C.) | 5 parts |

The raw materials excluding the paraffin wax fine particles were mixed in a mixer and then subjected to melt-kneading using a two-roll mill, and the kneaded product was rolled for cooling. This kneaded product and the paraffin wax fine particles were placed in a high-pressure cell 51 of an apparatus for producing particles 3 illustrated in FIG. 7. As a first compressive fluid, carbon dioxide was introduced under conditions of 70° C. and 65 MPa, followed by stirring for 1 hour. A melt obtained at this time had a viscosity of 20 mPa·s. Next, a back-pressure valve 46 was opened, and a pump 42 and a heater 48 were activated. Then, while the pressure and the temperature were maintained at 65 MPa and 70° C., respectively, supercritical nitrogen as a second compressive fluid was jetted from a nozzle 17. At this condition, a back-pressure valve 16 was opened, and a pump 52 was activated. Then, the melt was jetted while a second compressive fluid was supplied to the melt. At this time, a constant temperature and a constant pressure were maintained at 70° C. and 65 MPa, respectively, in the high-pressure cell 51 by adjusting a pump 32 and a back-pressure valve 53. The jetted melt was atomized followed by solidification. The solidified toner was regarded as [Toner 9].

### Example 10

In Example 10, the following was used as raw materials.

| | |
|---|---|
| Polyester Resin 2 | 95 parts |
| Colorant [Copper Phthalocyanine Blue (manufactured by | 5 parts |
| Dainichiseika Color & Chemicals Mfg. Co., Ltd., C.I. | |
| Pigment Blue 15:3)] | |
| Paraffin wax fine particles (melting point 79° C.) | 5 parts |

The toner raw materials excluding the paraffin wax fine particles were mixed in a mixer and then subjected to melt-kneading using a two-roll mill, and the kneaded product was rolled for cooling. This kneaded product and the paraffin wax fine particles were placed in a cell 11 of an apparatus for producing particles 5 in FIG. 9 and heated to 70° C. to plasticize a pressure plastic material. By actuating a pump 32 and opening a valve 33, carbon dioxide as a first compressive fluid was introduced under conditions of 70° C. and 10 MPa. Also, by actuating a pump 12 and opening a valve 13, the plasticized kneaded product and the first compressive fluid were mixed in a mixing device 15.

Next, a back-pressure valve 46 was opened, and while maintaining the conditions of 10 MPa and 70° C. using a pump 42 and a heater 48, supercritical nitrogen as a second compressive fluid was jetted from a nozzle 17. At this condition, a back-pressure valve 16 was opened, and while the second compressive fluid was supplied to a melt obtained by contacting the kneaded product and the first compressive fluid, the melt was jetted from the nozzle 17. At this time, the melt passing through an ultrahigh-pressure pipe 10f had a constant temperature and a constant pressure of 70° C. and 10 MPa, respectively, by adjusting the pump 12, the pump 32, the back-pressure valve 16 and the back-pressure valve 46. The jetted melt was atomized followed by solidification. The solidified toner was regarded as [Toner 10].

### Examples 11 to 14

[Toners 11 to 14] were respectively obtained in the same manner as Example 10 except that the process temperature, the process pressure and the nozzle diameter were changed to the values shown for Examples 11 to 14 in Table 2-1 to Table 2-3.

### Examples 15, 16

[Toners 15, 16] were obtained in the same manner as Example 10 except that [Polyester Resin 2] used in Example 10 was changed to [Polyurethane Resin 1] and that the process temperature, the process pressure and the nozzle diameter were changed to the values shown for Example 15 and Example 16 in Table 2-1 to Table 2-3.

### Example 17

[Polylactic Resin] was placed in a cell 11 of an apparatus for producing particles 5 in FIG. 9 and heated to 170° C. to plasticize the pressure plastic material. By actuating a pump 12 and opening a valve 13, carbon dioxide as a first compressive fluid was introduced at a condition of 170° C. and 65 MPa. Also, by actuating a pump 32 and opening a valve 33, the plasticized kneaded product and the first compressive fluid were mixed in a mixing device 15. Next, a back-pressure valve 46 was opened, and using a pump 42 and a heater 48 to maintain the pressure and the temperature to 65 MPa and 170° C., respectively, supercritical nitrogen as a second compressive fluid was jetted from a nozzle 17. At this condition, a back-pressure valve 46 was opened, and while the second compressive fluid was supplied to a melt obtained by contacting the kneaded product and the first compressive fluid, the melt was jetted from the nozzle 17. At this time, the melt passing through the mixing device 15 had a constant temperature and a constant pressure of 170° C. and 65 MPa, respectively, by adjusting a pump 12 and a pump 32. The jetted melt was atomized followed by solidification. The solidified particles were regarded as [Particles 17].

### Comparative Example 1

Non-modified polyester (a) obtained from ethylene oxide 2-mole adduct of bisphenol A, terephthalic acid and anhydrous phthalic acid and isocyanate group-containing prepolymer (b) (Mw: 35,000) obtained from ethylene oxide 2-mole adduct of bisphenol A, isophthalic acid, terephthalic acid, anhydrous phthalic acid and isophorone diisocyanate were obtained.

Also, a ketimine compound (c) was obtained from isophorone diamine and methyl ethyl ketone.

A beaker was charged with 20 parts of the prepolymer (b), 55 parts of the polyester (a) and 78.6 parts of ethyl acetate, followed by stirring for dissolution. Next, 10 parts of rice wax as a releasing agent (melting point: 61° C.) and 4 parts of carbon black were added, and it was stirred using a TK homomixer under conditions of 40° C., 12,000 rpm and 5 minutes. Thereafter, it was pulverized using a bead mill under conditions of 20° C. and 30 minutes. An obtained dispersion liquid is called as a toner-material oil dispersion liquid (d).

A beaker was charged with: 306 parts of ion-exchanged water; 265 parts of a 10-% suspension liquid of tricalcium phosphate; and 0.2 parts of sodium dodecylbenzenesulfonate, which was stirred using a TK homomixer at 12,000 rpm, and an aqueous dispersion liquid (e) was obtained. The toner-material oil dispersion liquid (d) and 2.7 parts of the ketimine compound (c) were added to the aqueous dispersion liquid (e), followed by stirring, and thereby a urea reaction was allowed to proceed.

After the organic solvent is removed within 1 hour under a reduced pressure and at a temperature of 50° C. or less, the dispersion liquid after the reaction (viscosity: 3,500 mPa·s) was subjected to filtration, washing, drying and finally air classification, and [Comparative Toner 1] having a spherical shape was obtained.

Also, for the toner of each example and comparative example, average values of maximum Feret diameters of releasing-agent particles and pores of the toner were obtained as follows. A cross-section of the particles was observed by an electron microscope, and a cross-sectional photograph was taken. The obtained cross-sectional photograph was processed and binarized using an image processing software (ImageJ, National Institutes of Health (NIH)), and a releasing-agent portions or pore portions were identified. Among the maximum Feret diameters of the identified releasing-agent particles or the pores, 30 of them were selected in order of larger diameter, and an average thereof was regarded as the average of the maximum Feret diameter of the releasing agent particles or the pores.

To 100 parts by mass of each toner obtained in the examples and the comparative examples, 0.7 parts by mass of hydrophobic silica and 0.3 parts by mass of hydrophobic titanium oxide were added, which was mixed in a HENSCHEL mixer for 5 minutes at a peripheral speed of 8 m/s. Powder after the mixing was passed through a mesh having a sieve opening of 100 μm, and coarse powder was eliminated.

Here, the toners obtained in the examples included a plurality of the particulate releasing agents encapsulated in the pressure plastic material. On the other hand, the toners obtained in the comparative examples included the releasing agent only partially encapsulated in the pressure plastic material, and regions where the releasing agent protruded from the pressure plastic material were observed.

Next, 5% by mass of this toner which had been subjected to this external additive treatment and 95% by mass of a copper-zinc ferrite carrier coated with a silicone resin and having an average particle diameter of 40 μm were homogeneously mixed and charged using a Turbula mixer with a rolling vessel for stirring. Thereby, two-component developers [Developers 1, 2, 3, 7, 9, 14, 15, 16 and 18] were prepared. Here, the toners used for [Developers 1, 2, 3, 7, 9, 14, 15, 16, 18] respectively correspond to [Toners 1, 2, 3, 7, 9, 14, 15 and 16, and Comparative Toner 1]. Here, no two-component developers were prepared for [Toners 4 to 6, 8 and 10 to 13].

Also, 0.7 parts by mass of hydrophobic silica and 0.3 parts by mass of hydrophobic titanium oxide were added each of 100 parts by mass of [Toners 1, 2, 3, 7, 9, 14, 15 and 16, Comparative Toner 1], which was mixed in a HENSCHEL mixer at a peripheral speed of 8 m/s for 5 minutes, and one-component developers [Developers 101, 102, 103, 107, 109, 114, 115, 116 and 118] were prepared. Here, the toners used in [Developers 101, 102, 103, 107, 109, 114, 115, 116 and 118] respectively correspond to [Toners 1, 2, 3, 7, 9, 14, 15 and 16, Comparative Toner 1] above. Here, no one-component developers were prepared for [Toners 4 to 6, 8 and 10 to 13].

### <Evaluation>

The obtained developers were respectively mounted on an image forming apparatus (IPSIO COLOR 8100, manufactured by Ricoh Company, Ltd., was used for evaluation of the two-component developers, and IMAGIO NEO C200, manufactured by Ricoh Company, Ltd., was used for evaluation of the one-component developer). Images were printed out and evaluated as follows. Results of the evaluation are shown in Table 3.

### <<Image Density>>

A solid image with a toner adhered amount as a low adhered amount of 0.3±0.1 mg/cm² was printed on plain paper (manufactured by Ricoh Company, Ltd., TYPE 6200) as transfer paper. Then, an image density was measured by a densitometer X-RITE (manufactured by X-Rite, Inc.) and evaluated based on the following criteria.

### —Evaluation Criteria—

A: Image density of 1.4 or greater;

B: 1.35 or greater but less than 1.4;

C: 1.3 or greater but less than 1.35; and

D: Less than 1.3.

### <<Toner Scattering>>

In an environment having a temperature of 40° C. and a relative humidity of 90%, an image forming apparatus (manufactured by Ricoh Company, Ltd., IPSIO COLOR 8100) remodeled and tuned for an oil-less fixing method was used as an evaluation apparatus. Using the above-mentioned evaluation apparatus, a durability test of consecutive printing of 100,000 sheets of a chart having an image area ratio of 5% was carried out using the developers, and conditions of the toner contamination in the copying machine were visually evaluated based on the following criteria.

### —Evaluation Criteria—

A: Favorable condition with no toner contamination was observed at all;

B: Good with no problem with contamination is slightly observed;

C: Fair with some contamination is observed;

D: Non-acceptable with severe contamination.

### <<Transfer Property>>

After a chart having an image area ratio of 20% was transferred from the photoconductor to paper, a transfer residual toner on the photoconductor right before cleaning was transferred with a SCOTCH tape (manufactured by Sumitomo 3M Ltd.) to a blank sheet. It was measured using a MacBeth reflection densitometer RD514 and evaluated based on the following criteria.

### —Evaluation Criteria—

A: The difference from the blank sheet was less than 0.005;

B: The difference from the blank sheet was 0.005 or greater but less than 0.011;

C: The difference from the blank sheet was 0.011 or greater but 0.020 or less;

D: The difference from the blank sheet was greater than 0.020.

### <<Charge Stability>>

A durability test of consecutive printing of 100,000 sheets of a character-image pattern having an image area ratio of 12% was carried out using the developers, and a change in an amount of charge at that time was evaluated. A small amount of a developer was collected from the sleeve, and the change in the amount of charge was obtained by a blow-off method and evaluated based on the following criteria.

### —Evaluation Criteria—

B: The change in the amount of charge was less than 5 μC/g;

C: The change in the amount of charge was 5 μC/g or greater but less than 10 μC/g;

D: The change in the amount of charge was exceeded 10 μC/g.

### <<Filming Property>>

Band charts having image area ratios of 100%, 75% and 50%, respectively were printed on 1,000 sheets, and then filming on the developing roller and the photoconductor was observed and evaluated based on the following criteria.

### —Evaluation Criteria—

A: No filming occurred at all;

B: Occurrence of slight filming was confirmed;

C: Filming occurred in streaks;

D: Filming occurred on the entire surfaces.

### <<Cleanability>>

A chart having an image area ratio of 95% was printed on 1,000 sheets, and then a transfer residual toner on the photoconductor which had passed the cleaning step was transferred to a blank sheet with a SCOTCH tape (manufactured by Sumitomo 3M Ltd.). It is measured using a MacBeth reflection densitometer RD514 and evaluated based on the following criteria.

### —Evaluation Criteria—

A: The difference from the blank sheet was less than 0.005;

B: The difference from the blank sheet was 0.005 or greater but less than 0.011;

C: The difference from the blank sheet was 0.011 or greater but 0.020 or less;

D: The difference from the blank sheet was greater than 0.020.

### <<Fixability>>

Using an apparatus that a fixing element of a electrophotographic copying machine (IPSIO CX8800, manufactured by Ricoh Company, Ltd.) with a TEFLON (registered trademark) roller as a fixing roller had been remodeled, a solid image having an adhered amount of a toner of 0.85±0.1 mg/cm² was formed on each of plain paper and transfer paper of thick paper, namely TYPE 6200 (manufactured by Ricoh Company, Ltd.) and copying and printing paper <135> (manufactured by Ricoh Business Expert Co., Ltd.) with a temperature of a fixing belt varied. At this time, an upper-limit temperature at which no hot-offset occurred on the plain paper was defined as the maximum fixing temperature. Also, a lower-limit temperature at which a remaining rate of an image density of a solid image on the thick paper rubbed with a pad was 70% or greater was defined as the minimum fixing temperature.

### —Evaluation Criteria of Maximum Fixing Temperature—

A: The maximum fixing temperature was 190° C. or greater;

B: The maximum fixing temperature was 180° C. or greater but less than 190° C.;

C: The maximum fixing temperature was 170° C. or greater but less than 180° C.; and

D: The maximum fixing temperature was less than 170° C.

### —Evaluation Criteria of Minimum Fixing Temperature—

A: The minimum fixing temperature was less than 115° C.;

B: The minimum fixing temperature was 115° C. or greater but less than 125° C.;

C: The minimum fixing temperature was 125° C. or greater but less than 155° C.; and

D: The minimum fixing temperature was 155° C. or greater.

TABLE 3

| | | | | | | | Min. | Max. |
|---|---|---|---|---|---|---|---|---|
| | Image | Toner | Transfer | Charge | Filming | Clean- | fixing | fixing |
| | density | scattering | property | stability | property | ability | temp. | temp |
| Developer 1 | A | A | A | B | A | A | A | B |
| Developer 2 | A | A | A | B | A | A | A | B |
| Developer 3 | B | B | B | B | A | A | B | B |
| Developer 7 | A | A | A | B | A | A | A | B |
| Developer 9 | B | B | B | B | A | A | B | B |
| Developer 14 | A | A | A | B | A | A | A | B |
| Developer 15 | A | A | A | B | A | A | A | B |
| Developer 16 | A | A | A | B | A | A | A | B |
| Developer 18 | A | A | A | B | B | B | C | B |
| Developer 101 | A | A | A | B | A | A | A | B |
| Developer 102 | A | A | A | B | A | A | A | B |
| Developer 103 | B | B | B | B | A | A | B | B |
| Developer 107 | A | A | A | B | A | A | A | B |
| Developer 109 | B | B | B | B | A | A | B | B |
| Developer 114 | A | A | A | B | A | A | A | B |
| Developer 115 | A | A | A | B | A | A | A | B |
| Developer 116 | A | A | A | B | A | A | A | B |
| Developer 118 | A | A | A | B | B | B | C | B |

Aspects of the present invention are, for example, as follows.

<1> A toner, including:

a binder resin; and

a releasing agent,

wherein the toner includes a pressure plastic material as the binder resin,

wherein the releasing agent includes a plurality of particulate releasing agents, and

wherein the particulate releasing agents forming domain phases are dispersed in the pressure plastic material forming a continuous phase.

<2> The toner according to <1>,

wherein the particulate releasing agents have an average maximum Feret diameter of 300 nm or greater but less than 1.5 μm.

<3> The toner according to <1> or <2>, wherein the pressure plastic material includes a resin containing a carbonyl group.
<4> The toner according to any one of <1> to <3>,

wherein the pressure plastic material includes a crystalline resin.

<5> The toner according to <4>,

wherein a content of the crystalline resin with respect to the binder resin is 50% by mass or greater.

<6> The toner according to any one of <1> to <5>,

wherein the toner includes no organic solvent.

<7> The toner according to any one of <1> to <6>,

wherein the toner includes pores inside the toner.

<8> The toner according to <7>,

wherein the pores have an average maximum Feret diameter of 300 nm or greater but less than 1.5 μm.

<9> A developer, including:

the toner according to any one of <1> to <8>.

<10> An image forming apparatus, including:

a photoconductor;

a latent electrostatic image forming unit, which forms a latent electrostatic image on the photoconductor;

a developing unit, which includes a developer including the toner according to any one of <1> to <8> and forms a visible image by developing the latent electrostatic image with the developer;

a transferring unit, which transfers the visible image to a recording medium; and

a fixing unit, which fixes the visible image transferred on the recording medium.

<11> A method for producing a toner, including:

mixing, wherein a pressure plastic material and a releasing agent are continuously supplied and joined to continuously form a mixture of the pressure plastic material and the releasing agent, and the mixture is continuously supplied to a next step;

melting, wherein a first compressive fluid and the mixture are brought into contact with each other to melt the mixture; and

granulating, wherein a melt obtained in the melting is jetted for granulation,

wherein the toner is a toner where particulate releasing agents forming domain phases are dispersed in the pressure plastic material forming a continuous phase.

<12> A method for producing a toner, including:

melting, wherein a pressure plastic material and a releasing agent are brought into contact with a first compressive fluid at a temperature below a melting point of the releasing agent to thereby melt the pressure plastic material; and

granulating, wherein a melt obtained in the melting is jetted at a temperature below the melting point of the releasing agent for granulation,

wherein the toner is a toner where particulate releasing agents forming domain phases are dispersed in the pressure plastic material forming a continuous phase.

<13> The method according to <11> or <12>, wherein the melt has a viscosity of 500 mPa·s or less.
<14> The method according to any one of <11> to <13>,

wherein the granulating includes supplying a second compressive fluid to the melt obtained in the melting while jetting the melt for granulation.

<15> A method for producing particles, including:

mixing, wherein a pressure plastic material and dispersed particles are continuously supplied and joined to continuously form a mixture of the pressure plastic material and the dispersed particles, and the mixture is continuously supplied to a next step;

melting, wherein a first compressive fluid and the mixture are brought into contact with each other to melt the mixture; and

granulating, wherein a melt obtained in the melting is jetted for granulation,

wherein the particles includes the pressure plastic material and a plurality of the dispersed particles, and the dispersed particles forming domain phases are dispersed in the pressure plastic material forming a continuous phase.

<16> A method for producing particles, including:

melting, wherein a pressure plastic material and dispersed particles are brought into contact with a first compressive fluid at a temperature below a melting point of the dispersed particles to thereby melt the pressure plastic material; and

granulating, wherein a melt obtained in the melting is jetted at a temperature below the melting point of the dispersed particles for granulation,

wherein the particles includes the pressure plastic material and a plurality of the dispersed particles, and the dispersed particles forming domain phases are dispersed in the pressure plastic material forming a continuous phase.

<17> The method according to <15> or <16>,

wherein the melt has a viscosity of 500 mPa·s or less.

<18> The method according to any one of <15> to <17>,

wherein the granulating includes supplying a second compressive fluid to the melt obtained in the melting while jetting the melt for granulation.

<19> Particles, including:

a pressure plastic material; and

pores inside the particles,

wherein the pores have an average maximum Feret diameter of 10 nm or greater but less than 500 nm.

### REFERENCE SIGNS LIST

1 Apparatus for producing particles
2 Apparatus for producing particles
3 Apparatus for producing particles
4 Apparatus for producing particles
5 Apparatus for producing particles
11, 21 Cell
31, 41 Cylinder
12, 22, 32, 42, 52 Pump
13, 23, 33, 43 Valve
16, 46 Back-pressure valve
38, 48 Heater
14, 15 Mixing device
17 Nozzle
51 High-pressure cell
T Toner

1: A toner, comprising:
a binder resin; and
a releasing agent,
wherein the toner comprises a pressure plastic material as the binder resin,
wherein the releasing agent comprises a plurality of particulate releasing agents, and
wherein the particulate releasing agents forming domain phases are dispersed in the pressure plastic material forming a continuous phase.

2: The toner according to claim 1,
wherein the particulate releasing agents have an average maximum Feret diameter of 300 nm to less than 1.5 μm.

3: The toner according to claim 1,
wherein the pressure plastic material comprises a resin comprising a carbonyl group.

4: The toner according to claim 1,
wherein the pressure plastic material comprises a crystalline resin.

5: The toner according to claim 4,
wherein a content of the crystalline resin with respect to the binder resin is 50% by mass or greater.

6: The toner according to claim 1,
wherein the toner comprises no organic solvent.

7: The toner according to claim 1,
wherein the toner comprises pores inside the toner.

8: The toner according to claim 7,
wherein the pores have an average maximum Feret diameter of 300 nm to less than 1.5 km.

9-14. (canceled)

15: A method for producing particles, comprising:
mixing, wherein a pressure plastic material and dispersed particles are continuously supplied and joined to continuously form a mixture of the pressure plastic material and the dispersed particles;
melting, wherein a first compressive fluid and the mixture are contacted with each other, wherein the mixture is supplied continuously from the mixing, thereby producing a melt; and
granulating, wherein the melt obtained is jetted,
wherein the particles comprise the pressure plastic material and a plurality of the dispersed particles, and the dispersed particles forming domain phases are dispersed in the pressure plastic material forming a continuous phase.

16. (canceled)

17: The method according to claim 15,
wherein the melt has a viscosity of 500 mPa·s or less.

18: The method according to claim 15,
wherein granulating comprises supplying a second compressive fluid to the melt while jetting the melt.

19: Particles, comprising:
a pressure plastic material which comprise
pores inside the particles,
wherein the pores have an average maximum Feret diameter of 10 nm to less than 500 nm.
